(19) United States
(12) Patent Application Publication
(10) Pub. No.: US 2026/0290181 A1
(43) Pub. Date: Sep. 24, 2026

(54) SYSTEM

(71) Applicant: SoftBank Group Corp., Tokyo (JP)

(72) Inventor: Kanako SAITO, Tokyo (JP)

(73) Assignee: SoftBank Group Corp., Tokyo (JP)

(21) Appl. No.: 19/549,165

(22) Filed: Feb. 25, 2026

Related U.S. Application Data
(60) Provisional application No. 63/773,709, filed on Mar. 18, 2025.

(51) Int. Cl. G09B 5/02; G06F 40/134; G06F 40/166; G06N 3/0475; G06V 10/25; G06V 10/764; G06V 20/40; G06V 30/146; G06V 30/19; G06V 30/413; G06V 40/16; G10L 17/02; G10L 17/18; G10L 19/02; G10L 21/028; G10L 25/18; G10L 25/24; G10L 25/63; H04N 19/50; H04N 19/70

(52) U.S. Cl. CPC G09B 5/02; G06F 40/134; G06F 40/166; G06N 3/0475; G06V 10/25; G06V 10/764; G06V 20/41; G06V 30/147; G06V 30/19; G06V 30/413; G10L 17/02; G10L 17/18; G10L 19/0204; G10L 21/028; G10L 25/18; G10L 25/24; H04N 19/50; H04N 19/70; G06V 40/174; G10L 25/63

(57) ABSTRACT

A system includes a processor configured to control an audio recording unit to record classroom audio in real time using a high-sensitivity microphone and collect lecture audio and student conversations, and to control a video recording unit to capture classroom video including blackboard content, teacher movements, and student states. The processor controls a data processing unit to analyze the recorded audio and video data and to extract important information using a generative artificial intelligence model. Based on the extracted information, the processor automatically summarizes key points of a lesson and significant conversations. The processor further controls a communication unit to transmit the summarized information to an email address of a student, enabling an absent student to quickly understand lesson content.

### CROSS-REFERENCE TO RELATED APPLICATION

This application claims the benefit of U.S. Provisional Application No. 63/773,709, filed on Mar. 18, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional educational environments, when a student is absent from a class, the student often has difficulty understanding what was taught and what was discussed among classmates during the absence. A teacher is frequently required to provide additional individual explanations, to prepare separate summary materials, or to repeatedly answer similar questions from absent students. This situation increases the workload of the teacher and reduces the time available for other educational activities. Furthermore, simple audio or video recordings of a class do not sufficiently solve this problem because such recordings require the absent student to spend nearly the same amount of time as the original class to review the content, and do not automatically highlight key points or important conversations. In addition, background noise in the classroom and the lack of structured summaries make it difficult for automatic systems to extract important information with high accuracy. As a result, absent students cannot efficiently obtain the essential information needed to catch up, and they may feel psychological or social barriers to rejoining classroom conversations and group activities. Therefore, there is a need for a system that can automatically record classroom audio and video, accurately extract important information using artificial intelligence, generate structured summaries of lesson key points and important discussions, and deliver the summarized information to absent students in a timely and convenient manner while reducing the burden on teachers.

### SUMMARY

In order to solve the above-described problems, a system is provided comprising a processor, wherein the processor is configured to control an audio recording unit to record audio in a classroom in real time using a high-sensitivity microphone and to collect in detail lecture audio from a teacher and conversation audio among classmates, and to control a video recording unit to capture video in the classroom using a camera and to record content on a blackboard, movements of the teacher, and states of classmates. The processor is further configured to control a data processing unit to analyze recorded audio data and recorded video data, to extract important information from the recorded audio data and the recorded video data by using a generative artificial intelligence model, and to automatically summarize key points of a lesson and important conversations based on the extracted important information. The processor is additionally configured to control a communication unit to transmit processed summarized information to an email address of a student so that an absent student can quickly understand a content of the lesson. In some embodiments, the processor is configured to control the audio recording unit to perform noise canceling to remove classroom noise and to record voices of the teacher and conversations of classmates clearly so that accuracy of extraction of important information by the generative artificial intelligence model from the audio data is improved. In other embodiments, the processor is configured to control the data processing unit to convert the audio data into text by using natural language processing techniques and to automatically classify and summarize key points of the lesson and important conversations by using a machine learning algorithm so that an absent student can efficiently obtain necessary information after returning and can smoothly participate in conversations with classmates.

The term “system” refers to a combination of hardware and software components including at least a processor, an audio recording unit, a video recording unit, a data processing unit, and a communication unit configured to cooperate to perform the claimed functions.

The term “processor” refers to one or more hardware processing elements, such as a central processing unit (CPU), microcontroller, digital signal processor (DSP), or other circuitry, configured by software or firmware to execute instructions and to control the operation of the audio recording unit, the video recording unit, the data processing unit, and the communication unit.

The term “audio recording unit” refers to hardware and associated control logic configured to capture sound signals in a classroom environment, including at least one high-sensitivity microphone and circuitry or software for converting the captured sound into digital audio data.

The term “video recording unit” refers to hardware and associated control logic configured to capture images or moving images of a classroom environment, including at least one camera and circuitry or software for converting captured images into digital video data.

The term “data processing unit” refers to hardware and software modules, which may be implemented on the same processor or on separate processing hardware, configured to perform analysis on audio data and video data, including artificial intelligence processing, natural language processing, machine learning, and summarization.

The term “communication unit” refers to hardware and software configured to transmit and receive data over a wired or wireless communication network, including functionality to send summarized information to an email address of a student.

The term “high-sensitivity microphone” refers to a microphone capable of detecting relatively low-level sound signals in a classroom and converting them into electrical or digital signals with sufficient quality for subsequent analysis by the data processing unit.

The term “classroom” refers to a physical environment in which a lesson is conducted by a teacher for one or more students and in which the audio recording unit and video recording unit operate to capture lecture content and classroom activities.

The term “lecture audio” refers to audio content spoken or presented by a teacher during a lesson, including explanations, instructions, examples, and other teaching-related speech.

The term “conversation audio” refers to audio content generated by students or other participants in the classroom, including questions, answers, discussions, and comments exchanged among classmates or between students and the teacher.

The term “blackboard” refers to any writing surface or display area used by the teacher to present written information, formulas, diagrams, or other visual teaching materials, including traditional chalkboards, whiteboards, and electronic boards.

The term “movements of the teacher” refers to visual actions performed by the teacher that are captured by the video recording unit, including gestures, pointing, writing on the blackboard, and other physical motions that provide context or emphasis to the lesson.

The term “states of classmates” refers to visual information related to students in the classroom, including their positions, reactions, participation, and other observable behaviors captured by the video recording unit.

The term “recorded audio data” refers to digital data representing sound captured by the audio recording unit during a lesson, including lecture audio and conversation audio.

The term “recorded video data” refers to digital data representing images or moving images captured by the video recording unit during a lesson, including the blackboard content, teacher movements, and states of classmates.

The term “generative artificial intelligence model” refers to a machine learning model, such as a large language model or multimodal model, configured to generate or transform content, and in this context used to analyze audio data and video data and to extract important information and generate summaries.

The term “important information” refers to portions of the recorded audio data and recorded video data that are determined by the data processing unit, using the generative artificial intelligence model or other algorithms, to be significant for understanding the lesson, including key concepts, main points, instructions, questions, and notable interactions.

The term “key points of a lesson” refers to essential concepts, topics, formulas, procedures, or conclusions that are emphasized by the teacher during the lesson and that are necessary for a student to understand the main subject matter.

The term “important conversations” refers to spoken exchanges involving the teacher and students that contribute significantly to understanding the lesson content, such as questions that clarify difficult concepts, discussions of alternative solution methods, and explanations resolving misunderstandings.

The term “summarized information” refers to condensed and structured data produced by the data processing unit from the recorded audio data and recorded video data, including textual summaries of key points of the lesson and important conversations, and optionally associated visual information.

The term “email address of a student” refers to an electronic mail destination identifier associated with a particular student, to which the communication unit can transmit the summarized information.

The term “absent student” refers to a student who is registered for a class but does not attend a specific lesson in person and who is intended to receive the summarized information to catch up with the missed content.

The term “noise canceling” refers to processing performed by the audio recording unit or associated circuitry or software to reduce or remove undesired background noise from captured audio signals, thereby improving the clarity of voices of the teacher and classmates.

The term “classify” refers to the operation of assigning portions of the audio data, text data, or extracted information to one or more categories, such as lesson key points, homework instructions, or questions, using rules, machine learning algorithms, or other methods.

The term “natural language processing techniques” refers to computational methods for analyzing, understanding, or generating human language, including speech-to-text conversion, tokenization, part-of-speech tagging, semantic analysis, and summarization.

The term “machine learning algorithm” refers to a computational method that learns patterns from data and uses those patterns to make inferences or predictions, and in this context is used to automatically classify and summarize lesson content and conversations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

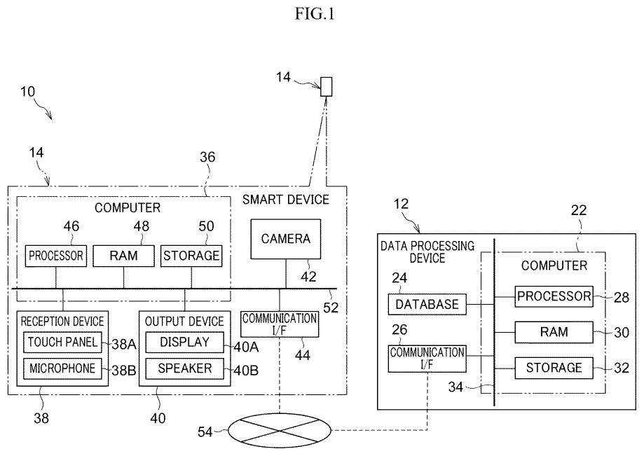

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

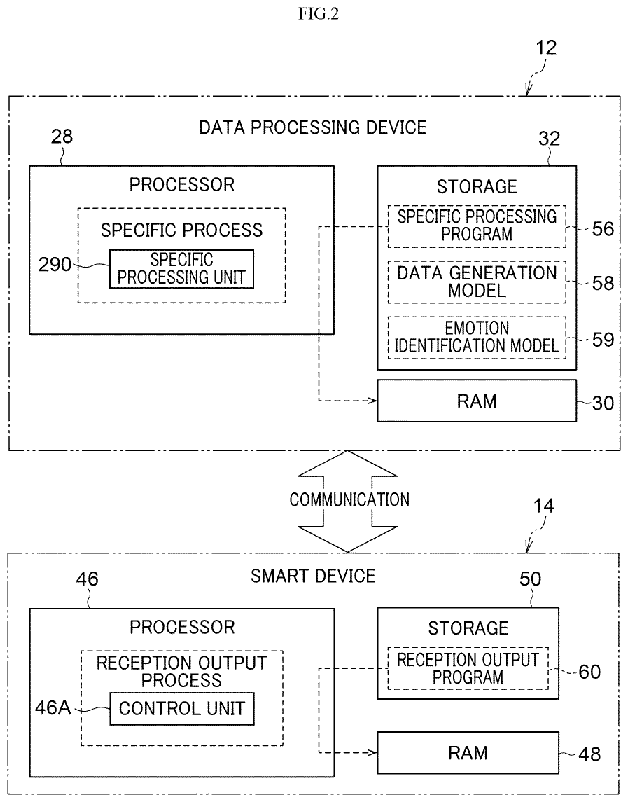

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for recording and distributing lessons or conferences mainly focus on capturing raw audio and video and delivering entire recordings to end users. Such systems require users to manually search through long recordings to find relevant segments, which is time-consuming and inefficient. Even when automatic speech recognition and generic summarization are applied, existing approaches typically treat audio transcripts and visual information (such as board content or presentation screens) as separate, uncoordinated data sources. As a result, summaries lack alignment with visual context, and users cannot easily navigate from summarized key points to the corresponding visual moments. Moreover, prior systems that employ a generative AI model generally use fixed, manually crafted prompts that are not dynamically adapted to lesson type, conference type, user attributes, or attendance status. This leads to inconsistent quality and relevance of generated summaries, and prevents the system from flexibly producing different output forms, such as key-point lists for absent students, detailed technical notes for advanced participants, or task-oriented action lists for meeting attendees. The inflexible handling of prompt sentences also makes it difficult to systematically control summary format, output style, and level of detail at scale.

From a computing-technology perspective, there is a need for an integrated processing architecture in which a processor coordinates: (i) time-synchronized acquisition, encoding, and storage of multimodal data; (ii) generation and selection of context-aware prompt sentences; (iii) invocation of a generative AI model with structured input data; and (iv) fusion of textual generation results with visual analysis results into navigable, machine-formatted integrated information. Existing architectures typically do not define, at the processor and data-structure level, how to construct input data for a generative AI model from synchronized character information and time information, nor how to re-bind generated structured information to original media segments for efficient retrieval and personalized notification. Accordingly, there is a need for an improved computer-implemented system and processing method in which a processor is specifically configured to (a) generate prompt sentences and input data in a programmatic, metadata-driven manner; (b) obtain structured summary and organization results from a generative AI model; (c) combine such results with time-aligned visual analysis; and (d) automatically generate and deliver integrated notification information tailored to user identification information. Such a system improves the computer's functionality in handling large volumes of multimodal educational or conference data by reducing manual review, enabling context-aware summarization, and providing structured, linkable outputs that can be efficiently consumed by users.

The specific processing by the specific processing unit 290 of the data processing device 12 in Example 1 is realized by the following means.

The present invention provides a server comprising a processor configured to acquire and time-synchronize audio information and video information from an educational space or a conference space, to perform compression encoding on the audio information and the video information and to generate a data set associated with identification information and time information, to execute speech recognition processing on audio information extracted from the data set to generate character information stored in association with the time information, to generate at least one prompt sentence that configures an input sentence for a generative AI model based on at least one of a lesson type, a conference type, a target attribute, and attendance information and based on the character information and the time information, to construct input data including the prompt sentence and the character information and to input the input data to the generative AI model, to obtain from the generative AI model a generation result including at least one of key points, important utterances, and preparation items and to store the generation result as structured information, to execute figure information recognition processing and character recognition processing on video information extracted from the data set and to associate detected display content and indicating actions with the character information and the generation result based on the time information, to integrate the structured information and visual analysis results into integrated information formatted as learning material information or conference record information, and to generate and transmit notification information including the integrated information to a user terminal via an electronic communication network based on user identification information. This enables an improved computer-implemented processing pipeline in which multimodal lesson or conference data are automatically transformed into context-aware, visually grounded, and user-specific integrated information, thereby reducing manual navigation of recordings, enhancing the accuracy and relevance of summaries produced by the generative AI model through dynamically selected prompt sentences, and improving the overall efficiency and technical performance of the information processing system.

The term “audio information” refers to information representing sound captured from an environment, including speech, ambient sound, and other audible events, encoded in an analog or digital format suitable for processing by an information processing apparatus.

The term “video information” refers to information representing images or image sequences captured from an environment, including still frames and moving pictures, encoded in a format suitable for storage, analysis, and display by an information processing apparatus.

The term “educational space” refers to a physical or virtual environment in which instructional activities are conducted, including but not limited to classrooms, lecture halls, training rooms, and online teaching sessions.

The term “conference space” refers to a physical or virtual environment in which meeting activities are conducted, including but not limited to meeting rooms, conference halls, teleconferences, and online collaboration sessions.

The term “time information” refers to information indicating temporal positions or intervals, including timestamps, time indices, or time ranges, that can be used to associate audio information, video information, and character information in chronological order.

The term “identification information” refers to information that uniquely or distinctively identifies an entity, including but not limited to an educational session, a conference session, a user, a group, a device, or a data set.

The term “data set” refers to a collection of one or more units of encoded audio information and encoded video information, associated with identification information, time information, and related metadata, and suitable for storage, transmission, and processing by an information processing apparatus.

The term “information processing apparatus” refers to a device or combination of devices including at least one processor and at least one memory, configured to execute programs for performing operations on data, such as servers, computers, or computing systems.

The term “speech recognition processing” refers to processing that converts audio information representing speech into corresponding character information by using pattern recognition, statistical modeling, machine learning, or other computational techniques.

The term “character information” refers to information representing text or symbols in a machine-readable form, including but not limited to letters, numerals, mathematical expressions, and punctuation, which can be stored, searched, and processed by an information processing apparatus.

The term “prompt sentence” refers to a sentence or set of sentences that specifies an instruction, constraint, or context for a generative AI model, and that is included as part of input data to control a type, style, or level of detail of output generated by the generative AI model.

The term “generative AI model” refers to a computational model implemented by software and executed by hardware, which is trained using machine learning or deep learning techniques to generate output information, such as text, in response to input data including prompt sentences.

The term “input data” refers to data provided to a generative AI model, including at least one prompt sentence and at least one portion of character information, and optionally including additional metadata or parameters that influence an output of the generative AI model.

The term “generation result” refers to information output by a generative AI model in response to input data, including but not limited to summaries, lists of key points, extracted items, explanations, or other structured or unstructured content.

The term “structured information” refers to information that is arranged according to a predefined schema, format, or data structure, such as a list, table, tree, or tagged document, enabling systematic access, storage, and processing by an information processing apparatus.

The term “figure information recognition processing” refers to processing that analyzes video information to detect or recognize graphical elements, shapes, diagrams, or spatial arrangements, including but not limited to board content, presentation slides, and gesture-indicating regions.

The term “character recognition processing” refers to processing that analyzes video information or image information to detect and convert visual characters into character information, including optical character recognition for text, numerals, and symbols.

The term “display content” refers to visual elements presented within video information, including characters, figures, diagrams, images, or graphical marks that convey information to observers.

The term “indicating actions” refers to physical or virtual gestures or operations that visually indicate or emphasize parts of display content, including but not limited to pointing, underlining, circling, highlighting, or focusing movements.

The term “analysis result” refers to information generated by processing audio information, video information, character information, or combinations thereof, including recognition outputs, detected events, and associations between multiple modalities.

The term “integrated information” refers to information obtained by combining a generation result from a generative AI model with one or more analysis results of video information or other data, organized into a coherent structure such as learning material information or conference record information.

The term “learning material information” refers to integrated information configured for educational use, including but not limited to key concepts, explanations, examples, formulas, and references, arranged to support study or review by a learner.

The term “conference record information” refers to integrated information configured for meeting use, including but not limited to discussion summaries, decisions, action items, participant contributions, and references to corresponding segments of audio information and video information.

The term “user identification information” refers to information used to identify or distinguish a user or a group of users, including but not limited to identifiers, account information, roles, attributes, or attendance status.

The term “notification information” refers to information generated for delivery to a user terminal, including at least part of integrated information and optionally including links, references, or metadata that enable access to associated audio information, video information, or character information.

The term “user terminal” refers to an end-user device capable of communicating with an information processing apparatus via an electronic communication network, including but not limited to a personal computer, a tablet device, a smartphone, or another display-equipped communication device.

The term “electronic communication network” refers to a wired or wireless communication infrastructure that enables data exchange between devices, including but not limited to the Internet, local area networks, wide area networks, and mobile communication networks.

The term “lesson type” refers to classification information indicating a category or subject of an educational session, including but not limited to mathematics, science, language, or professional training.

The term “conference type” refers to classification information indicating a category of a meeting session, including but not limited to status meetings, technical reviews, planning meetings, or training conferences.

The term “target attribute” refers to information describing characteristics of an intended user or audience, including but not limited to grade level, expertise level, role, language preference, or accessibility requirement.

The term “attendance information” refers to information indicating whether a user was present, absent, or partially present at an educational session or a conference session, and optionally including attendance time ranges.

The term “summary format” refers to one or more rules or specifications defining a structural style of a summary, including but not limited to bullet-point lists, paragraph summaries, question-and-answer forms, or hierarchical outlines.

The term “output style” refers to characteristics of how generated information is presented, including but not limited to tone, level of technical detail, vocabulary difficulty, or use of headings and labels.

The term “level of detail” refers to a degree of granularity or completeness in generated information, including but not limited to concise summaries, standard summaries, and extended explanations.

The term “key point summary information” refers to information that highlights principal ideas, conclusions, or focal topics extracted from an educational session or a conference session.

The term “utterance organization information” refers to information that organizes spoken contributions, including but not limited to grouping utterances by speaker, topic, or viewpoint, and indicating relationships such as agreement or disagreement.

The term “task presentation information” refers to information that describes tasks, assignments, action items, or follow-up activities derived from an educational session or a conference session.

The term “review material information” refers to information selected or generated to support review of previously conducted sessions, including summaries, key examples, links to specific segments, and practice questions.

The term “reference information” refers to information that enables access or navigation to related data, including but not limited to identifiers, hyperlinks, timestamps, or indices that point to associated audio information, video information, or character information.

In one embodiment, a terminal operates as a capture device installed in an educational space or a conference space, and a server operates as an information processing apparatus located in a data center or on a cloud computing platform. The terminal comprises a processor, a memory, a microphone unit, a camera unit, a storage unit, and a communication interface. The server comprises at least one processor, a main memory, a nonvolatile storage device, and a network interface. The terminal and the server execute respective software modules to implement the functions described below.

The terminal uses a microphone unit including one or more high-sensitivity acoustic sensors to acquire audio information in the educational space or the conference space. The terminal samples the audio signal, for example at 16 kHz and 16-bit resolution, and stores the sampled audio frames in a circular buffer in memory. The terminal applies noise-cancelling processing by executing a digital signal processing program that performs spectral subtraction, adaptive filtering, and beamforming. In one example, the terminal executes a program compiled from C language using a digital signal processing library on an embedded operating system such as a real-time operating system. The terminal calculates short-time Fourier transforms of the audio frames, estimates noise spectra during periods detected as silence, and subtracts the estimated noise from subsequent frames. As a result, the terminal generates cleaned audio frames with reduced background noise and improved signal-to-noise ratio, which improves the accuracy of later speech recognition on the server.

The terminal uses a camera unit including an image sensor and a wide-angle lens to acquire video information in the educational space or the conference space. The terminal captures image frames, for example at 30 frames per second with high-definition resolution, and stores the frames in a frame buffer. The terminal associates each audio frame and each video frame with time information generated by a local clock synchronized with the server clock, for example via a network time protocol. The terminal thus maintains audio information and video information in chronological order in a time-indexed data structure, such as a sequence of frame objects each including time information, a frame identifier, and a data pointer.

The terminal performs compression encoding on the audio information and the video information. The terminal executes a media codec module that encodes the audio information into a compressed audio stream using an audio compression algorithm such as a transform-based codec, and encodes the video information into a compressed video stream using a motion-compensated prediction algorithm. The terminal segments the compressed streams into data units, such as segments of a predetermined duration (for example, 30 seconds or 1 minute), and associates identification information and time information with each segment. The terminal generates a data set as a container including a header region storing identification information, time range, and configuration parameters, and a payload region storing the compressed audio and video streams.

The terminal transmits the data set to the server via a communication interface that supports wireless or wired communication. The terminal executes a communication control program that performs connection management, encryption negotiation, and retransmission control. For example, the terminal uses a transport-layer protocol with acknowledgment and retransmission mechanisms. The terminal maintains a send queue data structure for data sets that have not been acknowledged by the server and resends such data sets if a timeout occurs. This communication control reduces packet loss and ensures that the server receives a complete and time-synchronized set of audio and video information, which contributes to stable downstream processing.

The server receives the data set via the network interface and stores the data set in a storage subsystem, such as a disk array or a distributed storage service. The server maintains an index table in a relational database, in which each entry includes identification information, time range, a file path or object identifier for the stored data set, and status flags such as “pending recognition,” “recognition completed,” and “summary generated.” This index table enables the server to efficiently retrieve data sets for further processing and to manage processing state.

The server extracts audio information from the received data set by executing a media demultiplexing program. The server decodes the compressed audio stream into linear pulse-code modulated samples and stores the audio samples in a buffer. The server executes speech recognition processing by running an automatic speech recognition engine implemented as a neural network model, for example a model of an encoder-decoder architecture with attention mechanisms. The server divides the audio samples into overlapping windows and extracts acoustic features, such as Mel-frequency cepstral coefficients and log-Mel spectrograms. The server feeds the acoustic features into the neural network model, which has been trained on large corpora of speech and text pairs using a supervised learning procedure with a cross-entropy loss function and gradient-based weight updates. The server obtains character information as a sequence of tokens corresponding to recognized words or subword units, together with time information indicating estimated start and end times of each token.

The server stores the character information and the associated time information in a structured data format, such as a table or document in which each record contains a token, a speaker label when available, a start time, and an end time. By maintaining this time-aligned character information, the server can later associate textual content with specific audio segments and video frames. This specific data structure improves search and retrieval efficiency, because the server can perform time-range queries and keyword queries without rescanning raw audio. The server generates a prompt sentence for a generative AI model based on at least one of a lesson type, a conference type, a target attribute, and attendance information. The server references a configuration database that stores multiple prompt templates in association with metadata fields. For example, the server retrieves a first prompt template when the lesson type is mathematics and the target attribute is a middle-school learner, and retrieves a second prompt template when the conference type is a technical design review. The server then fills template variables in the selected prompt template using session-specific parameters, such as lesson title or date.

The server constructs input data for the generative AI model by concatenating the prompt sentence and relevant portions of the character information. In one example, the server composes the following prompt sentences as plain text:

“From the following classroom transcript, extract and summarize the points that the teacher emphasized, and present them as numbered bullet points.”

“From the following transcript of a class discussion, identify the most important opinions of each student and summarize areas of agreement and disagreement.”

“Based on the extracted blackboard formulas and the transcript, create a step-by-step explanation of how the teacher derived each formula.”

“Create a concise study guide that includes key terms, short definitions, and two practice questions with answers suitable for middle-school students.”

The server supplies the prompt sentence and the character information as input tokens to a generative AI model implemented as a neural network. In one embodiment, the generative AI model is a transformer-based sequence-to-sequence model that includes a multi-layer self-attention mechanism, feedforward layers, and layer normalization. The server stores the model parameters, such as weight matrices and bias vectors, in a model storage area and loads them into memory when the model is invoked. The server executes the model on a processor and optionally on an accelerator, such as a graphics processing device, to perform matrix multiplications and nonlinear transformations efficiently.

The server performs inference by encoding the input tokens into contextual embeddings and then decoding output tokens one by one based on probability distributions computed by the model. The server uses a decoding strategy such as beam search or top-k sampling, constrained by maximum length and formatting rules specified in the prompt sentence. For example, when the prompt sentence specifies numbered bullet points, the server configures decoding parameters to favor outputs that include numerical prefixes and line breaks. By programmatically controlling input structure and decoding strategy, the server guides the model to generate structured information rather than arbitrary free-form text.

The server obtains a generation result that includes at least one of key points, important utterances, and preparation items. The server parses the generation result into a structured representation, such as a list of sections, items, and references. For example, the server recognizes headings, numbering patterns, and key phrases to partition the generation result into “Key Concepts,” “Discussion Highlights,” and “Next Preparation” sections. The server stores this structured information in the database with explicit fields that can be indexed and retrieved programmatically, thereby improving the machine-readability of summary information.

The server also extracts video information from the data set and executes figure information recognition processing and character recognition processing. The server uses an image processing library to decode video frames and to select frames at time points aligned with significant textual events, such as when a new topic begins or when a formula is mentioned. The server applies character recognition processing by running an optical character recognition algorithm on regions of interest, such as a board region or a presentation slide region. The server detects equations, labels, and bullet points as character information, which can be compared or merged with the character information obtained from speech recognition. The server executes figure information recognition processing to detect diagrams, shapes, or structured layouts on the board or screen. In one embodiment, the server applies edge detection, contour extraction, and shape classification to identify geometric figures such as arrows, boxes, and coordinate axes. The server may also estimate indicating actions by analyzing motion vectors of a teacher's hand or an indicator object across sequential frames. When the server detects a pointing motion toward a region containing a newly written formula or a highlighted phrase, the server records a link between this indicating action, the detected display content, and the corresponding time information.

The server associates the detected display content and indicating actions with the character information and the generation result based on time information. The server maintains an association table that records correlations between textual segments, visual elements, and generated summary items. For example, the server links a particular key point in the generation result to a frame identifier of a video frame showing a formula, and to a time range during which the teacher verbally explains that formula. This linking enables navigation from the summary back to specific multimodal evidence and supports consistent cross-modal retrieval.

The server integrates the structured information from the generative AI model and the visual analysis results into integrated information formatted as learning material information or conference record information. The server composes an integrated document that includes text sections, inline references to images, and navigational links that encode time information as parameters. The server may generate an HTML document, a markup document, or another structured format that a client application can render. Because the server uses explicit data structures for links and sections, the integrated information can be consumed not only by human users through a graphical interface but also by other programs for further processing, such as indexing or recommendation.

The server generates notification information based on user identification information. The server queries a user database to determine which users are associated with the session and whether the users were absent or present, and which target attribute is assigned to each user. The server then selects appropriate subsets and presentation forms of the integrated information. For an absent learner, the server may emphasize key point summary information and review material information; for a participant responsible for follow-up tasks in a conference, the server may emphasize task presentation information and utterance organization information. The server composes notification information that includes links to the integrated information and optionally includes an embedded short summary in the body text.

The server transmits the notification information to user terminals over an electronic communication network, using, for example, an email protocol or a push notification mechanism. The server records delivery status and access logs in the database, which can later be analyzed to improve prompt sentence selection or to adjust the level of detail for future sessions.

The user operates a user terminal, such as a personal computer or a smartphone, to access the integrated information. The user opens a communication application, receives the notification information, and activates a link that causes a client application to request the integrated information from the server. The server responds with the structured document and associated media, and the user terminal renders the document and plays back associated audio and video as needed. When the user selects a particular key point, the client application sends a request including the associated time information to the server or to a streaming subsystem, and the corresponding video segment is retrieved and presented. This coordinated interaction between the summary structure and the media retrieval flow is enabled by the server's explicit maintenance of time-aligned and cross-referenced data structures.

From the perspective of computer technology, this system improves operation of the server and the terminal beyond mere automation of human tasks. The server reduces computational load and network traffic by segmenting audio and video data and by performing recognition and generative processing only on relevant segments identified by time-range indexing, instead of processing entire long recordings monolithically. The server improves accuracy of summarization by combining time-aligned character information from speech recognition with independent character recognition from video frames and with detected indicating actions, which provides cross-validation of content and context. The server also improves data management by maintaining structured associations between character information, visual elements, and generation results, thereby enabling efficient indexing, retrieval, and personalization.

The generative AI model is not used as a black box with arbitrary input; instead, the server programmatically constructs prompt sentences and input data based on metadata and internal state. The server enforces a non-conventional, machine-oriented prompting strategy that encodes explicit constraints on summary format, output style, and level of detail. This differs from simple human-level use of language models and yields consistent, machine-parsable outputs. The server can evaluate generation results against structural expectations, detect deviations, and if necessary regenerate or post-process outputs. Such closed-loop control over model invocation and result structuring optimizes computational resources and improves robustness of the overall processing pipeline.

In another embodiment, the server uses a different type of generative AI model, for example a recurrent neural network or a hybrid model that combines convolutional layers for local feature extraction and attention layers for global context modeling. The server may adjust hyperparameters such as learning rate, hidden layer size, and dropout rate during training to achieve a balance between accuracy and inference speed. The server may also apply data augmentation methods during training, such as mixing noise into audio, applying time-stretching, or paraphrasing textual inputs, to improve generalization. Although training is typically performed offline, the stored model parameters and their structure directly influence how the server processes runtime input data in the deployed system.

In yet another embodiment, the server adopts alternative data structures. For example, the server may store the time-aligned character information in a graph database, where nodes represent textual segments or visual elements and edges represent temporal adjacency or semantic relations. The server may then perform graph traversal to identify clusters of related content for summarization. This graph-based approach further differentiates the system from straightforward linear document summarization and provides technical advantages in terms of flexible content navigation and complex query support.

The terminal may be implemented using different hardware platforms, such as an embedded control board with a microcontroller and basic codecs, or a more powerful single-board computer capable of running a full operating system and advanced on-device preprocessing. In a variant, the terminal may perform preliminary speech activity detection and discard long periods without speech, thereby reducing data volume sent to the server and lowering network usage and server load, while preserving essential content. The server is able to handle such variants because processing is based on time-aligned segments and metadata, not on any specific physical implementation of the terminal.

Through these embodiments, the server, the terminal, and the user interact in a technically coordinated manner. The server uses specific data structures, neural network architectures, and prompt sentence control logic to transform raw multimodal data into integrated information. This architecture achieves measurable technical effects, including improved recognition and summarization accuracy through multimodal alignment, reduced computation time and bandwidth consumption through targeted processing of relevant segments, and enhanced data organization that supports efficient search and personalized delivery that could not be achieved by simple human viewing or naïve automation of human summarization work.

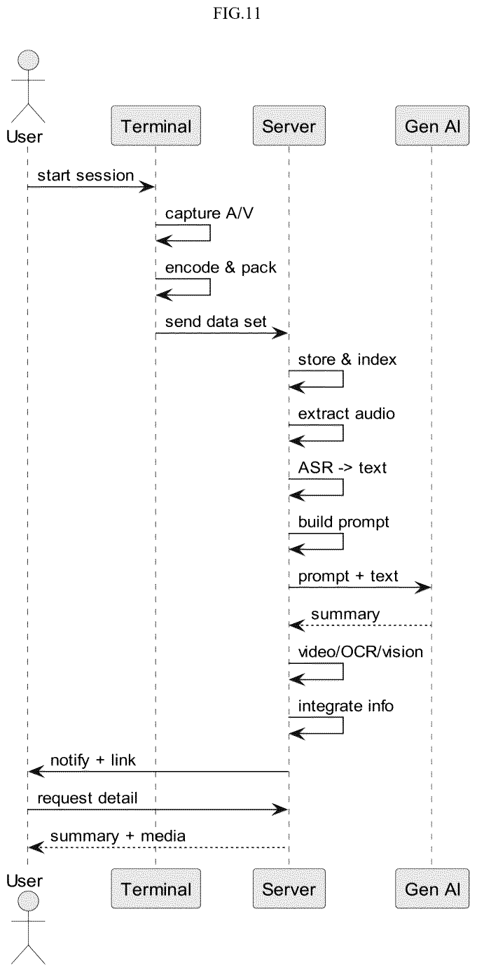

The following describes the processing flow using FIG. 11.

### Step 1:

The terminal acquires raw classroom or conference signals as input.

The terminal receives analog sound from a microphone and optical images from a camera, samples the sound into digital audio frames, and samples the images into digital video frames.

The terminal assigns a timestamp to each audio frame and each video frame using a local clock so that the output is a time-indexed sequence of audio frames and video frames stored in memory.

### Step 2:

The terminal performs noise reduction on the time-indexed audio frames as input.

The terminal segments the audio into short windows, computes frequency spectra, estimates background noise, and subtracts the noise spectrum from each frame.

The terminal outputs cleaned audio frames with improved signal-to-noise ratio, each still associated with the original timestamp.

### Step 3:

The terminal performs preliminary encoding on cleaned audio frames and raw video frames as input.

The terminal applies an audio encoder to compress the audio frames into an audio bitstream and applies a video encoder to compress the video frames into a video bitstream while preserving timestamp information.

The terminal outputs encoded audio segments and encoded video segments, each segment labeled with identification information and a start-end time range.

### Step 4:

The terminal packages encoded audio segments and encoded video segments as input into a data set container.

The terminal creates a header that includes session identification information, terminal identification information, time range, and codec configuration, and then attaches the encoded audio and video as payload.

The terminal outputs complete data sets ready for transmission, each representing a fixed duration of synchronized audio and video.

### Step 5:

The terminal transmits each data set as input to the server.

The terminal opens a secure communication channel, places the data set in a send queue, sends the data, and waits for an acknowledgment from the server.

The terminal outputs a transmission status for each data set, and in case of failure, the terminal retains the data set in the queue for retransmission.

### Step 6:

The server receives data sets from the terminal as input.

The server verifies integrity of each data set using headers and checksums, and stores the data set in persistent storage with an index entry containing identification information and time range.

The server outputs stored data objects and corresponding index records, each marked as pending for further analysis.

### Step 7:

The server extracts audio information from stored data sets as input.

The server demultiplexes the container, decodes the compressed audio bitstream into linear audio samples, and segments the samples into analysis windows aligned with timestamps.

The server outputs a sequence of audio sample windows with precise time information, ready for speech recognition.

### Step 8:

The server performs speech recognition on audio sample windows as input.

The server computes acoustic features such as spectrograms, feeds them into a neural network-based recognition model, and decodes the most probable token sequence using a trained language model.

The server outputs character information, including tokens, words, or subwords, each associated with start and end timestamps derived from the acoustic alignment.

### Step 9:

The server structures the character information and timestamps as input into a searchable format.

The server creates records that store each text segment with associated time range and optional speaker label, and inserts these records into a database table or document store.

The server outputs a time-aligned transcript structure that can be queried by time, keyword, or speaker.

### Step 10:

The server analyzes session metadata and the time-aligned transcript as input to generate a prompt sentence.

The server reads lesson type, conference type, target attribute, and attendance information, selects an appropriate prompt template, and fills placeholders with session-specific details.

The server outputs a prompt sentence that specifies how a generative AI model should summarize or organize the transcript.

### Step 11:

The server constructs input data for the generative AI model using the prompt sentence and a transcript segment as input.

The server concatenates the prompt sentence and selected transcript text into a single token sequence, assigns segment markers, and formats control parameters such as desired output length or structure.

The server outputs structured input data that encodes both instructions and content for the generative AI model.

### Step 12:

The server submits the structured input data as input to the generative AI model.

The server executes a transformer-based inference process that embeds tokens, applies attention layers, and computes probability distributions over output tokens, using decoding rules consistent with the prompt sentence.

The server outputs a generation result, for example a set of key points, organized summaries, or preparation items expressed as text.

### Step 13:

The server parses the generation result as input into structured information.

The server analyzes headings, numbering, and linguistic cues, splits the text into sections such as “Key Concepts,” “Important Utterances,” and “Tasks,” and stores each element in dedicated fields.

The server outputs structured summary records linked to time ranges and session identifiers.

### Step 14:

The server extracts video frames and time information from the data sets as input.

The server decodes video segments, samples frames at selected timestamps that align with transcript events, and defines regions of interest such as board areas or slide areas.

The server outputs a set of sampled frames with associated time information and region coordinates.

### Step 15:

The server performs character recognition processing on sampled frames as input.

The server applies an optical character recognition algorithm on board and slide regions, converts detected visual text into character information, and attaches timestamps corresponding to each frame.

The server outputs recognized visual text segments with time alignment, ready to be compared with spoken content.

### Step 16:

The server performs figure information recognition processing on sampled frames as input.

The server applies edge detection, contour analysis, and shape classification to identify diagrams, arrows, boxes, and highlighted regions, and computes motion vectors between consecutive frames to detect indicating actions such as pointing.

The server outputs detected visual elements and indicating actions, each labeled with type, location in the frame, and time.

### Step 17:

The server integrates transcript information, recognized visual text, and detected visual elements as input to build multimodal associations.

The server matches time ranges between spoken segments and visual events, links key phrases to corresponding board content, and associates indicating actions with emphasized concepts.

The server outputs an association structure that relates textual segments, visual items, and timestamps.

### Step 18:

The server combines the structured summary from the generative AI model and the multimodal association structure as input.

The server enriches each summary item with references to video frames, equations, diagrams, and specific time ranges, and updates the structured summary records to include these references.

The server outputs integrated information formatted as learning material information or conference record information, where each item is linkable to underlying media.

### Step 19:

The Server Generates Notification Information Using Integrated Information and User identification information as input.

The server selects which sections of the integrated information are relevant to each user based on attributes and attendance, formats a message that may include a short textual summary and links, and embeds references to specific time-stamped media segments.

The server outputs individualized notification messages for each user.

### Step 20:

The server transmits notification messages to user terminals as input to communication channels.

The server uses an email protocol or a messaging API to send the messages, records delivery results, and optionally stores access tokens or deep links to the integrated information.

The server outputs transmission logs and status indicators that confirm successful delivery or identify errors.

### Step 21:

The user receives notification information as input on a user terminal.

The user opens the message in a mail client or communication application, reads the brief summary, and activates a link embedded in the notification.

The user outputs a request to the server for the full integrated information corresponding to the selected session or key point.

### Step 22:

The server receives a request from the user terminal as input.

The server verifies the user identification information and access rights, retrieves the corresponding integrated information and associated media references, and assembles a response document or page.

The server outputs a rendered data package containing structured text, links, and media entry points.

### Step 23:

The user views the integrated information as input on the user terminal.

The user scrolls through key concepts, clicks on specific items to jump to relevant video segments, and optionally expands sections containing detailed explanations or tasks.

The user outputs interaction events, such as play commands or navigation choices, which can be logged and used by the server to refine future prompt sentences or summary strategies.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional care support systems that record audio and video in living environments suffer from several technical limitations that impede accurate, timely, and scalable understanding of complex multimodal care scenes. First, existing systems typically treat audio and video analysis as separate, loosely coupled processes. As a result, such systems do not reliably correlate spoken instructions, health-related utterances, and physical actions in a unified time-aligned representation, which leads to loss of important contextual relationships and reduces the usefulness of any downstream automated reasoning. Second, many systems apply static speech recognition and rule-based natural language processing pipelines that are not optimized for noisy, multi-speaker care environments; these pipelines often fail to extract nuanced intent, priorities, or clinical significance from conversational data, and they lack mechanisms for dynamically refining their behavior based on real-world user feedback. Third, while generative AI models and prompt sentences have emerged as powerful tools for high-level reasoning and summarization, existing care-recording systems typically invoke such models in an ad hoc, non-systematic manner, without a well-defined architecture for constructing context-rich prompt sentences that integrate both linguistic and behavioral features, and without a feedback loop for adaptively improving the prompts and alert criteria over time. Fourth, user-initiated queries to AI systems are often handled outside the core recording and processing pipeline, resulting in duplicated processing, inconsistent views of the underlying data, and increased computational overhead.

Accordingly, there is a need for an improved computer-implemented system that: (i) acquires and synchronizes audio and video streams in a structured, machine-readable form; (ii) performs integrated multimodal processing to extract speaker-typed textual content and time-aligned action events; (iii) automatically constructs and issues context-aware prompt sentences to a generative AI model to obtain machine-readable summary and evaluation information; (iv) generates alerts and structured records in a manner that can be programmatically tuned; and (v) supports user-driven prompt sentences and adaptive learning, such that the underlying computational pipeline, including prompt design and alert decision criteria, is progressively improved based on accumulated interaction history. The technical problem addressed by the present invention is to provide such an integrated architecture and processing flow that improve the accuracy, responsiveness, adaptability, and computational efficiency of computer systems that analyze multimodal care data using generative AI models.

The specific processing by the specific processing unit 290 of the data processing device 12 in Application Example 1 is realized by the following means.

The present invention provides a server comprising one or more processors coupled to a memory, the one or more processors being configured to control acquisition of audio information from an audio recording unit and video information from an image recording unit in a living environment, to associate the audio information and the video information with identification information and time-series information, to perform speech recognition and natural language processing on the audio information so as to generate character information and to classify utterance contents according to a type of speaker, to perform posture estimation processing and action recognition processing on the video information so as to extract care actions and care-recipient behaviors in association with the time-series information, to construct context information including the character information and the action recognition results, to automatically generate, on the basis of the context information, structured prompt sentences for a generative AI model that instruct extraction of instruction contents, extraction of health-related utterances, and evaluation of appropriateness of the care actions, to input the structured prompt sentences and the context information into the generative AI model so as to obtain machine-readable summary information and evaluation information, to determine, on the basis of the summary information and the evaluation information, whether predetermined conditions indicating changes in health state, risky behaviors, or failures to execute emergency instructions are satisfied, to generate alert information and structured output information for each care recipient and for each care provider, and to transmit the structured output information and the alert information to a user terminal and further to receive user-initiated prompt sentences and historical confirmation or evaluation operations and adaptively update the structured prompt sentences and the predetermined conditions based on the historical operations. This enables an improved computer-implemented multimodal analysis pipeline that tightly integrates audio, video, and generative AI processing, achieves more accurate and context-aware extraction and evaluation of care-related events, supports efficient handling of user-driven queries within the same computational framework, and progressively refines prompt design and alert criteria through adaptive learning, thereby enhancing the technical performance, scalability, and robustness of the underlying information processing system.

The term “audio information” refers to digital data representing sound captured in a living environment, including speech signals from one or more speakers, annotated with at least time information and optionally direction or source identification information.

The term “audio recording unit” refers to a hardware and software combination that uses an acoustic input device to capture sound in a living environment and to output corresponding audio information in a machine-processable format.

The term “high-sensitivity acoustic input device” refers to a transducer or array of transducers configured to convert low-level sound pressure variations in a living environment into electrical or digital signals with sufficient resolution for speech analysis.

The term “video information” refers to digital data representing a sequence of images or frames captured in a living environment, including spatial, temporal, and color information sufficient to detect motions and behaviors of persons.

The term “image recording unit” refers to a hardware and software combination that uses an image pickup device to capture images or video in a living environment and to output corresponding video information in a machine-processable format.

The term “image pickup device” refers to an optical sensing apparatus configured to convert incident light from a scene in a living environment into image data, such as a digital camera or image sensor.

The term “wide-angle optical element” refers to an optical component or assembly configured to extend a field of view of an image pickup device so as to capture a larger portion of a living environment in a single frame.

The term “living environment” refers to a physical space in which care activities occur, including but not limited to a residential room, a facility room, or a similar interior or partially enclosed area in which a care provider and a care recipient interact.

The term “care provider” refers to a human operator, such as a caregiver, nurse, or staff member, who performs assistance, monitoring, or support actions for a care recipient in a living environment.

The term “care recipient” refers to a human subject receiving assistance, monitoring, or support from a care provider in a living environment, such as a patient, resident, or user requiring care.

The term “communication unit” refers to a hardware and software combination configured to transmit and receive data between a system and external devices or servers over one or more communication networks.

The term “information processing apparatus” refers to one or more computing devices, such as servers or virtual machines, that include at least a processor and a memory and that are configured to execute programs for analyzing audio information and video information.

The term “time-series information” refers to data indicating a temporal order or time relationship among events, frames, or samples, including timestamps, time indices, or relative time offsets.

The term “identification information” refers to data used to distinguish among entities, sessions, or devices, including but not limited to identifiers for a facility, room, care provider, or care recipient.

The term “speech recognition” refers to a computational process that receives audio information as input and produces character information or text representing the linguistic content of spoken utterances.

The term “natural language processing” refers to a set of computational techniques applied to character information to analyze, interpret, classify, or transform human language, including segmentation, tagging, entity recognition, and semantic extraction.

The term “character information” refers to textual data generated from audio information by speech recognition, including recognized words, phrases, or sentences and optionally associated metadata such as timestamps and speaker labels.

The term “type of speaker” refers to a classification category assigned to a speaker in a conversation, such as care provider, care recipient, or other participant, used to distinguish roles in analysis.

The term “posture estimation processing” refers to a computational process that infers body positions, joint locations, or poses of persons in video information, enabling identification of physical postures and movements.

The term “action recognition processing” refers to a computational process that analyzes video information to detect and classify actions or behaviors of persons, such as standing, sitting, walking, supporting, or falling.

The term “care actions” refers to physical behaviors performed by a care provider toward a care recipient, including assistance, support, monitoring, and intervention activities, as detected from video information.

The term “care-recipient behaviors” refers to physical behaviors exhibited by a care recipient, including movements, postures, or reactions, as detected from video information.

The term “context information” refers to a combined representation that includes at least character information derived from audio information and results of action recognition processing derived from video information, and that is used as input to a generative AI model.

The term “generative AI model” refers to a machine-implemented model configured to receive a prompt sentence and associated context information and to generate output information, such as summaries, evaluations, or structured data, based on learned patterns.

The term “prompt sentence” refers to a machine-processable instruction or query provided to a generative AI model, specifying a task to be performed on given context information, such as extraction, summarization, or evaluation of care-related content.

The term “structured prompt sentence” refers to a prompt sentence constructed according to a predefined format or template, optionally including explicit instructions regarding output structure, to enable systematic and machine-readable responses from a generative AI model.

The term “summary information” refers to machine-readable data produced by a generative AI model that condenses or abstracts content from context information, such as main instructions, key health events, or overall descriptions of care interactions.

The term “evaluation information” refers to machine-readable data produced by a generative AI model that assesses aspects of care actions or care-recipient behaviors, including appropriateness, safety, compliance, or quality metrics.

The term “predetermined conditions” refers to one or more criteria or rules defined in advance for determining whether particular patterns in summary information or evaluation information indicate a relevant event, such as a health change, risky behavior, or emergency non-compliance.

The term “alert information” refers to data indicating that at least one predetermined condition is satisfied, including type, severity, timing, and context of the condition, and intended for notification to a user terminal.

The term “output information” refers to structured data generated for each care recipient and for each care provider, including at least summary information, evaluation information, and optionally aggregated statistics or records.

The term “user terminal” refers to an end-user computing device, such as a workstation, tablet device, or mobile device, that includes a display device and that communicates with the server to receive and present output information and alert information.

The term “display device” refers to a visual output apparatus associated with a user terminal, configured to present time-series event information, alert information, evaluation information, or responses from a generative AI model to a human user.

The term “arbitrary prompt sentence” refers to a prompt sentence that is freely specified by a user via a user terminal, rather than being pre-defined by a system template, and that instructs the generative AI model to perform a user-specified analysis.

The term “recorded session information” refers to data associated with one or more recording intervals, including identifiers, timestamps, transcripts, and action logs, selected as context for processing by a generative AI model.

The term “history information” refers to stored data representing user interactions with system outputs, including confirmation operations, evaluation operations, acknowledgments, or dismissals of alerts, associated with corresponding summary information, evaluation information, and alert information.

The term “confirmation operation” refers to an input action by a user indicating that a particular piece of summary information, evaluation information, or alert information has been reviewed, acknowledged, or accepted.

The term “evaluation operation” refers to an input action by a user providing feedback regarding correctness, usefulness, or relevance of particular summary information, evaluation information, or alert information.

The term “adaptive learning” refers to a process by which the system automatically modifies prompt sentences, determination criteria, or processing parameters on the basis of accumulated history information, in order to improve performance of generated summary information, evaluation information, and alert information.

In one or more embodiments, the invention is implemented by cooperation of a server, one or more terminals, and one or more users in a care environment. The server includes one or more processors and a memory storing program instructions. The terminals include an audio recording unit, an image recording unit, a communication unit, and a local controller. The users include care providers, care recipients, and supervisory personnel who operate a user terminal.

The terminal acquires multimodal care data in a living environment. The terminal uses a high-sensitivity acoustic input device, such as a microphone array including multiple micro-electro-mechanical microphones, to capture audio signals in the living environment.

The terminal samples the audio at a predetermined sampling rate, for example 16 kHz or 48 kHz, and converts the analog signals into digital samples using an analog-to-digital converter integrated in an embedded processor. The terminal executes a beamforming algorithm on the digitized samples, the algorithm being implemented, for example, in C++ code running on an embedded processor such as an ARM-based system-on-chip. The terminal thereby derives direction-of-arrival information for each time window and increases the gain for signals coming from an estimated direction of a care provider or care recipient. By combining beamforming with a noise suppression algorithm, such as a spectral subtraction method or a Wiener filter implemented using a digital signal processing library, the terminal reduces environmental noise and reverberation. This preprocessing increases the signal-to-noise ratio before the audio information is transmitted to the server, thereby reducing computational load in subsequent processing and improving speech recognition accuracy.

The terminal acquires video information using an image recording unit. The terminal includes an image pickup device, such as a complementary metal-oxide semiconductor sensor, and a wide-angle optical element configured to provide a field of view sufficient to cover a care area, for example 120 degrees. The terminal captures frames at a predetermined frame rate, for example 30 frames per second, and encodes the frames using a video compression standard, such as an H.264 codec. The terminal performs basic on-device preprocessing including resolution adjustment and optionally region-of-interest cropping to focus on a bed area or a walking corridor. The terminal associates each frame with timestamps synchronized to the audio stream through a local clock, and the terminal embeds the timestamps as metadata in a container format, such as an MP4 file. This synchronized packaging allows later multimodal alignment on the server with low overhead.

The terminal controls a communication unit to transmit the audio information and the video information to the server. The terminal uses a wireless or wired communication interface, such as an IEEE 802.11 interface or an Ethernet interface, and the terminal sends the data using a secure protocol such as Transport Layer Security over Hypertext Transfer Protocol.

The terminal attaches identification information to each transmission, including identifiers for the facility, room, care provider, care recipient, and device. The terminal optionally performs local buffering and retry control when communication is unstable, thereby reducing packet loss and avoiding redundant retransmission load on the network.

The server receives and stores the transmitted multimodal data. The server uses an application server program, for example implemented with a web framework such as a general-purpose server framework, to expose an application programming interface endpoint. The server receives audio and video container files and metadata and stores the audio and video container files in an object storage system, such as a network-attached storage device or a distributed object store, and registers descriptive records in a relational database management system, such as a structured query language database. The server maintains a specific data schema that includes tables for sessions, audio segments, video segments, speakers, and events. Each table includes foreign keys that link segments to sessions and to care participants. Such a structured schema improves retrieval efficiency for later analysis and reduces the need for repeated parsing of raw container files.

The server performs audio processing and speech recognition using dedicated software components. The server extracts raw audio tracks from the container files using a multimedia processing library, such as a program that performs demultiplexing and decoding. The server converts the audio to a single channel and to a standard sampling rate. The server then applies a voice activity detection algorithm that classifies short audio windows as speech or non-speech using features such as energy, zero-crossing rate, and spectral entropy. By discarding non-speech windows, the server decreases the amount of data passed to subsequent neural speech recognition, which reduces processing time and GPU utilization.

The server uses an automatic speech recognition engine, which may be implemented as a neural network model of the sequence-to-sequence type with an encoder-decoder architecture and an attention mechanism. In one embodiment, the server uses a transformer-based speech recognition model having multiple self-attention layers in the encoder, and positional encodings to represent temporal order. The encoder receives sequences of acoustic feature vectors, such as log-Mel filterbank coefficients computed from the audio frames. The decoder generates token sequences representing text characters or subword units. The model parameters are trained using supervised learning on speech corpora, with an objective function such as a cross-entropy loss between predicted token distributions and reference transcriptions. The server executes the trained model on a graphics processing unit or other accelerator, and the server receives character information including recognized tokens with time alignment.

The server performs natural language processing on the character information. The server segments the character information into sentences and turns using a language-specific tokenizer and sentence boundary detector. The server applies a part-of-speech tagging model and a dependency parsing model, such as a neural sequence labeling model based on a bidirectional recurrent neural network, to obtain syntactic structure. The server performs named entity recognition to detect mentions of symptoms, body parts, medications, time expressions, and actions. The server may use a transformer-based language model fine-tuned for entity recognition, with a token classification head trained using supervised learning and a loss function such as cross-entropy. The server then classifies utterances into speaker types, such as care provider or care recipient, by combining diarization results from acoustic processing and lexical cues. This classification results in labeled utterance units that are stored in the database, each unit including fields for text, speaker type, start time, end time, and recognized entities.

The server performs posture estimation and action recognition on the video information. The server uses a deep neural network for human pose estimation, such as a convolutional neural network that outputs two-dimensional heat maps for body joint locations for each frame. The server then connects detected joints into skeleton representations for each individual and tracks skeletons across frames using a tracking algorithm, such as a Kalman filter and data association based on joint positions. The server derives feature sequences from the skeletons, such as joint angles, velocities, and relative positions. For action recognition, the server applies a temporal model, such as a temporal convolutional network or a recurrent neural network, to these feature sequences. The server classifies intervals of frames into action labels, such as standing up, sitting down, walking, being supported by another person, or nearly falling. The server assigns confidence scores to each action instance and discards instances below a threshold to reduce false detections. The server stores resulting actions in the database as structured records including fields for action type, actor role (care provider or care recipient), start time, end time, and confidence.

The server constructs context information by aligning textual utterances and action events on a common time axis. The server uses timestamps to associate utterances before and after an action with the action itself. For example, when a care provider utterance such as “Please stand up slowly” occurs within a predetermined window before a “care recipient starts standing” action, the server links these items and marks an instruction-action pair. The server generates context objects that include, for each care session or sub-session, a list of utterances with speaker types and entities, a list of actions, and derived relations such as instruction-action pairs. These context objects are serialized in a structured format and used as input to generative AI processing.

The server generates structured prompt sentences for a generative AI model. The server uses a template-based prompt generator that inserts factual context into natural language instructions. For example, the server may generate a prompt sentence of the following form: “You are an assistant that analyzes multimodal records in a care environment. Based on the following conversation and action list, extract all explicit instructions given by the care provider to the care recipient. For each instruction, output the original text, a short summary, the purpose of the instruction, and whether the instruction appears to have been followed according to the actions. Conversation: [ . . . ]. Actions: [ . . . ].”

In another example, the server may generate a prompt sentence such as:
“From the following conversation between a care provider and a care recipient, identify all statements that indicate changes in the care recipient's health condition, including pain, dizziness, appetite, and sleep. For each statement, output the original text and a normalized description of the symptom and a severity level (low, medium, high). Conversation: [ . . . ].”

In yet another example, the server may generate a prompt sentence such as:
“Using the conversation and the detected care actions listed below, evaluate the quality and safety of the care provided in this session. Describe appropriate actions, identify risks, and propose specific recommendations for improvement. Conversation: [ . . . ]. Actions: [ . . . ].”

The server uses a generative AI model, which in one embodiment is a transformer-based autoregressive language model with multiple self-attention layers and feed-forward layers. The model is trained on a large corpus of text data to predict the next token given preceding tokens. In some implementations, the model is further fine-tuned on domain-specific care records to adapt its generation behavior. During fine-tuning, the server uses supervised signals in the form of example prompts and desired outputs, and optimizes a loss function such as cross-entropy using gradient-based methods, updating model weights with an optimizer such as Adam. The server configures the generative AI model with inference parameters, such as temperature and maximum output length, to control determinism and verbosity.

The server inputs the prompt sentence and the context information to the generative AI model. The server concatenates instructions and context into a single token sequence and feeds the sequence to the model. The server then obtains model-generated token sequences representing summary information and evaluation information. To ensure machine-readable structure, the server constrains or instructs the model, via the prompt sentence, to output sections with specific labels or a predefined listing format. The server parses the output to extract elements such as instruction lists, health event summaries, risk descriptions, and recommendations. The server then stores these elements as structured records in the database. By delegating high-level reasoning over complex multimodal context to a large neural model optimized for language understanding, the system can capture nuanced relationships between utterances and actions that are not easily expressed by fixed rules.

The server determines whether predetermined conditions are satisfied based on the summary information and the evaluation information. The server implements a rule module that operates on structured fields in the summary information and the evaluation information. Examples of predetermined conditions include: a condition that is satisfied when a reported symptom severity reaches a high level multiple times within a fixed interval; a condition that is satisfied when an instruction labeled as “emergency” appears in the summary information and the corresponding action log lacks a confirming action within a threshold time; and a condition that is satisfied when the evaluation information contains a classification of “high risk” for fall-related actions. The server evaluates these conditions using logical expressions and threshold comparisons, not by generic keyword search, which allows the system to reason over normalized symptom labels and structured action relations. The server generates alert information that includes fields such as alert type, severity, associated care recipient, time period, and a reference to specific sessions and evidence summaries.

The server generates structured output information for each care recipient and each care provider. The server aggregates per-session records over defined time windows, such as daily or weekly periods, and computes statistics such as counts of specific instructions, frequency of high-severity symptoms, and distribution of risk levels. The server assembles these results in hierarchical data structures that include, for each care recipient, chronological entries with summary information and alert information, and, for each care provider, aggregated care quality indicators derived from evaluation information. This structured representation improves retrieval, filtering, and visualization performance on the user terminal, and it reduces the need for repeated generative inference when users request overviews.

The server transmits the structured output information and the alert information to a user terminal. The server uses a communication interface to provide a programmatic interface that allows terminals to request updates. The server transmits only incremental updates when possible, such as newly generated alerts or summaries since the last request, which reduces network load and improves responsiveness. The user terminal receives the data and renders a dashboard interface, for example implemented using a general-purpose user interface framework. The terminal displays time-series event information, alert lists, and evaluation summaries, enabling the user to view complex AI-generated content in a structured and organized form.

The user interacts with the system using a user terminal. The user views the displayed information and may perform operations such as acknowledging alerts, marking outputs as correct or incorrect, and selecting care sessions for detailed review. The user may also input arbitrary prompt sentences for additional analysis. For example, the user may input:
“Summarize how the care recipient's sleep-related complaints have changed over the past week.”
“Compare today's mobility assistance to that of the previous day and highlight any differences related to safety.”
“List all incidents in which the care recipient reported dizziness and describe the context and subsequent actions.”

The terminal transmits the arbitrary prompt sentence and an indication of selected recorded session information to the server.

The server processes user-initiated prompt sentences. The server receives the arbitrary prompt sentence and retrieves corresponding context information from the database, such as transcripts and action logs for the specified period. The server embeds this context and the arbitrary prompt sentence into a new prompt for the generative AI model, using a template that ensures the model understands the task and the desired output structure. The server invokes the same generative AI model, with parameters suitable for interactive responses, and obtains answer text. The server may perform post-processing, such as splitting paragraphs, extracting bullet points, or truncating overly long responses, to fit on the user interface. The server returns the processed answer to the terminal, which displays the content. This architecture allows flexible analytical queries without re-implementing domain logic for each query, while reusing the same multimodal context and improving computational efficiency. The server performs adaptive learning based on history information. The server records user interactions with alerts and summaries, including which alerts were acknowledged quickly, which alerts were repeatedly dismissed, and which generative outputs were flagged as inaccurate. The server maintains history information that relates particular prompt configurations and rule thresholds to observed user reactions. The server uses this information to adjust internal parameters. For example, the server may increase the threshold for generating alerts of a certain type when many such alerts are dismissed as not relevant, or may modify structured prompt sentences to emphasize certain aspects, such as safety issues, when users consistently request more detail. The server may use a reinforcement learning or bandit-style algorithm to select among alternative prompt templates or threshold sets, using reward signals derived from user actions, such as the frequency with which users use or ignore certain outputs. By controlling prompt generation and decision rules at the server level and updating them based on measured interaction data, the system improves technical performance over time without manual reprogramming.

The described embodiments improve computer technology in several respects. By performing early multimodal synchronization and noise-aware audio preprocessing at the terminal and structured storage at the server, the system reduces redundant computation and enables efficient reuse of processed segments across different analyses. By combining specialized neural network architectures for speech recognition, language understanding, posture estimation, and action recognition with a generative AI model guided by structured prompt sentences, the system achieves higher accuracy in identifying clinically relevant events and care instructions than conventional rule-based or single-modality systems. The use of explicit context objects and structured outputs reduces the need for ad hoc textual parsing and allows deterministic rule modules to operate on normalized features, improving reliability and debuggability. The adaptive learning mechanism that updates prompt sentences and decision criteria based on history information optimizes computational resources by reducing unnecessary alerts and focusing generative inference on cases that provide high value, thus decreasing average processing time per useful output. In addition, the architecture tightly couples sensor control, data processing, and AI inference in a manner that cannot be replicated by manual human review, because the system exploits high-dimensional feature representations, consistent temporal alignment, and statistical learning that exceed human capacity for continuous monitoring, thereby providing a concrete improvement in the operation of computer systems that process multimodal care data.

Variations and alternative embodiments are possible. The server may run on a distributed cluster in which different nodes perform audio processing, video processing, and generative inference, respectively, with a message queue for coordination. The terminal may be implemented as a mobile robot, a wall-mounted device, or a wearable device, and may include additional sensors such as depth cameras or inertial sensors. The generative AI model may be replaced or supplemented by other neural architectures, such as encoder-decoder models or retrieval-augmented models that consult a knowledge base of care guidelines. The action recognition pipeline may use alternative features, such as optical flow or three-dimensional joint positions from depth sensors. The speech recognition and natural language processing components may be adapted to different languages and dialects. The system may be configured to omit or encrypt certain fields for privacy, while preserving the structural properties necessary for technical processing. In all such embodiments, the server, the terminals, and the users cooperate according to the described architecture to implement multimodal acquisition, analysis, and adaptive generative processing, thereby realizing the technical advantages of the invention.

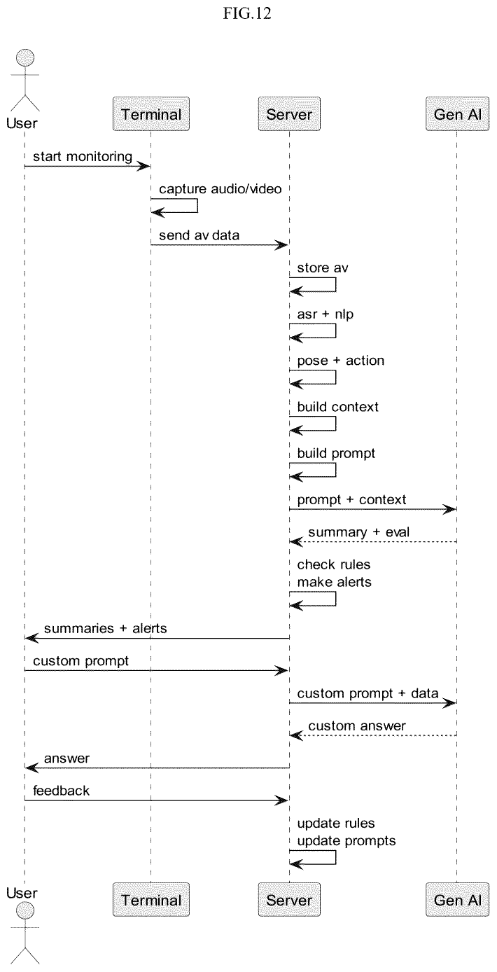

The following describes the processing flow using FIG. 12.

### Step 1:

The terminal acquires raw audio signals in the living environment.

The terminal uses a high-sensitivity acoustic input device to receive analog sound waves as an input and converts the analog signals into digital samples via an analog-to-digital converter.

The terminal applies beamforming and noise-suppression processing to the digital samples, using direction-of-arrival estimation and frequency-domain filtering, so that the terminal generates an output consisting of cleaned audio frames annotated with time information and estimated speaker direction.

### Step 2:

The terminal acquires raw video frames in the living environment.

The terminal uses an image pickup device with a wide-angle optical element to receive light from the scene as an input and converts the incident light into digital image frames. The terminal performs resolution adjustment and optional region-of-interest cropping on the frames, and associates each frame with a timestamp synchronized to the audio stream, so that the terminal generates an output consisting of preprocessed video frames with time information.

### Step 3:

The terminal packages and transmits synchronized audio and video data to the server.

The terminal receives as input the cleaned audio frames, the preprocessed video frames, and identification information for the facility, room, care provider, and care recipient. The terminal multiplexes the audio and video into a container format, appends metadata fields including identifiers and time-series information, and uses a communication unit to send the container file to the server over a secure network protocol, so that the terminal generates an output consisting of one or more transmitted data packets containing synchronized multimodal data.

### Step 4:

The server ingests, validates, and stores the received multimodal data.

The server receives as input the data packets from the terminal through an application programming interface. The server verifies authentication data, checks container headers and codec information to ensure format validity, and extracts metadata such as identifiers and timestamps. The server writes the audio-video container to object storage and inserts corresponding records into a relational database, linking each recording to a session identifier, so that the server generates an output consisting of stored file references and database entries ready for further processing.

### Step 5:

The server separates audio and video streams and normalizes audio for analysis.

The server receives as input a stored container file reference and associated metadata. The server uses a multimedia processing library to demultiplex the container, extracting an audio stream and a video stream. The server converts the audio stream to a standard format, such as mono 16 kHz PCM, and applies voice activity detection to classify short windows as speech or non-speech. The server discards non-speech windows or marks them for skipping, so that the server generates an output consisting of normalized speech segments with timestamps and a mapping to the original session.

### Step 6:

The server performs automatic speech recognition and speaker classification.

The server receives as input the normalized speech segments and their timestamps. The server computes acoustic features, such as log-Mel filterbank coefficients, and feeds the feature sequences into a sequence-to-sequence neural speech recognition model to obtain text tokens for each segment. The server then executes a diarization algorithm that groups acoustic segments into clusters corresponding to distinct speakers and maps clusters to speaker types such as care provider or care recipient. As a result, the server generates an output consisting of character information (transcripts) with speaker labels and time alignment for each utterance.

### Step 7:

The server performs natural language processing to extract linguistic structure and entities.

The server receives as input the character information with speaker labels. The server applies tokenization and sentence segmentation to divide the character information into sentences and utterance units. The server uses a part-of-speech tagger and a dependency parser to assign syntactic roles to tokens, and uses a named entity recognizer to identify domain-relevant entities such as symptoms, body parts, medications, and time expressions. The server normalizes the identified entities into canonical forms using a predefined vocabulary, so that the server generates an output consisting of linguistically annotated utterances with speaker type, entity tags, and normalized labels.

### Step 8:

The server performs posture estimation on video frames.

The server receives as input the video stream associated with the session and the timestamps of the frames. The server passes sampled frames through a pose-estimation neural network that outputs two-dimensional joint heat maps for each person in the frame. The server post-processes the heat maps to determine joint coordinates and constructs skeleton representations for each detected person. The server associates skeletons with frame timestamps and tracks each person across time using a tracking algorithm, so that the server generates an output consisting of time-series skeleton data for each detected participant.

### Step 9:

The server performs action recognition from skeletal time-series data.

The server receives as input the time-series skeleton data. The server computes temporal features such as joint angles, velocities, and relative distances between joints, and then feeds sliding windows of these features into a temporal classification model, such as a temporal convolutional network or recurrent neural network. The server classifies each window into one of multiple action categories, for example standing up, sitting down, walking, being supported, or nearly falling, and assigns confidence scores. The server merges overlapping windows of the same action type to form action intervals, so that the server generates an output consisting of structured action events with action type, actor identifier, start time, end time, and confidence.

### Step 10:

The server aligns utterances and actions to construct context information.

The server receives as input the linguistically annotated utterances and the structured action events. The server uses timestamp information to identify temporal relationships, such as utterances occurring before, during, or after specific actions within a configurable time window. The server detects instruction-action pairs by locating care provider utterances containing imperative patterns followed by matching care recipient actions, and detects health-related utterances that precede or follow abnormal actions such as near falls. The server encodes these relationships in context objects that contain, for each session or sub-session, lists of utterances, lists of actions, and cross-references between them, so that the server generates an output consisting of rich multimodal context information for generative processing.

### Step 11:

The server constructs structured prompt sentences for the generative AI model.

The server receives as input the multimodal context information. The server selects a prompt template according to a task type, such as instruction extraction, health event extraction, or care quality evaluation. The server fills template placeholders with session-specific data, including excerpts of conversation and summarized action lists, and constructs a natural language instruction that specifies required outputs and constraints. For example, the server may generate a prompt sentence such as “From the following conversation between a care provider and a care recipient, identify all statements that indicate changes in the care recipient's health condition, including pain, dizziness, appetite, and sleep. For each statement, output the original text, a normalized description of the symptom, and a severity level (low, medium, high). Conversation: [ . . . ]”. As a result, the server generates an output consisting of one or more task-specific prompt sentences paired with corresponding context data.

### Step 12:

The server invokes the generative AI model and obtains structured AI outputs.

The server receives as input the task-specific prompt sentences and associated context data.

The server tokenizes the prompt sentences and context, feeds the tokens into a generative AI model configured as an autoregressive transformer network, and runs inference to generate output token sequences that satisfy the prompt instructions. The server decodes the tokens into text and parses the text according to expected sections or list formats, extracting elements such as summarized instructions, health-related utterances, risk descriptions, and recommendations. The server validates that required fields are present and corrects minor formatting errors when possible, so that the server generates an output consisting of machine-readable summary information and evaluation information associated with each context.

### Step 13:

The server evaluates predetermined conditions and generates alerts.

The server receives as input the summary information and evaluation information for a session or time period. The server applies rule logic that evaluates conditions such as counts of high-severity symptoms, presence of unfulfilled emergency instructions, or occurrence of high-risk actions indicated by the evaluation information. The server performs threshold comparisons and logical combination of condition results, and when at least one predetermined condition is satisfied, the server creates an alert record with type, severity, references to supporting summaries, and time bounds. The server aggregates these records per care recipient and per care provider, so that the server generates an output consisting of structured alert information and updated session summaries.

### Step 14:

The server prepares and transmits structured output information to user terminals.

The server receives as input the updated session summaries and alert records. The server aggregates data over configurable time windows, constructs hierarchical output objects that group events for each care recipient and care provider, and prunes or compresses details to reduce data size while preserving key information. The server uses the communication unit to transmit the output objects and alert records to user terminals upon request or via push mechanisms. As a result, the server generates an output consisting of display-ready datasets enabling efficient rendering of time-series event information, alerts, and evaluations on user interfaces.

### Step 15:

The user reviews system outputs and issues optional custom prompt sentences.

The user receives as input the displayed summaries and alerts on a user terminal. The user selects one or more care sessions, scrolls through time-series displays, and acknowledges or dismisses alerts by operating user interface controls. The user may also input a custom prompt sentence, such as “Summarize how the care recipient's sleep-related complaints have changed over the past week,” and specify a time range or resident identifier. The user's operations result in an output consisting of user feedback signals, including acknowledgments and evaluations, and optional custom prompt sentences with selected context identifiers, which the user terminal sends to the server.

### Step 16:

The server processes user-initiated prompt sentences for ad-hoc analysis.

The server receives as input the custom prompt sentence and the selected session identifiers.

The server retrieves corresponding transcripts, action logs, and prior AI summaries for the specified scope, constructs a new prompt by combining the user's instruction with the retrieved context, and feeds the combined prompt into the generative AI model. The server obtains a generated answer, performs light post-processing to organize the text into sections or bullet points suitable for display, and returns the answer to the user terminal, so that the server generates an output consisting of an ad-hoc AI-generated analysis tailored to the user's specific query.

### Step 17:

The server updates history information and adaptively refines prompts and rules.

The server receives as input logs of user interactions, including which alerts were acknowledged or dismissed, which AI responses were consulted or rated, and which prompts were frequently used. The server aggregates these interaction records into history information indexed by alert type, prompt template, and condition set. The server applies an adaptation algorithm that adjusts rule thresholds and selects among alternative prompt templates based on performance metrics such as true-alert acknowledgment rates or user satisfaction indicators. The server updates internal configuration tables for prompt templates and condition parameters, so that the server generates an output consisting of refined prompt definitions and rule settings that improve accuracy and reduce unnecessary alerts in subsequent processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional lecture recording systems typically capture audio and video and then deliver raw or lightly processed recordings to learners. Although such systems may use automatic speech recognition or simple keyword extraction, they generally treat audio and video streams independently and do not leverage multimodal emotional indicators present in classroom interactions. As a result, these systems fail to provide machine-generated summaries that effectively reflect which parts of a lesson were confusing, which parts were well understood, and which discussions were engaging for learners.

From a computer-technology standpoint, existing systems suffer from several limitations. First, they do not provide an integrated processing pipeline in which acoustic recognition, image analysis, multimodal feature extraction, and emotion estimation are coordinated in a time-synchronized manner on server-side computing resources. This leads to inefficient use of computational resources, fragmented data processing, and difficulty in correlating different modalities along a unified time axis. Second, conventional systems do not use emotion-aware conditioning when invoking generative AI models; they simply feed transcripts or static metadata into a text-generation engine without encoding time-series emotional states or dynamically structuring prompt sentences based on emotion profiles. This results in summaries and feedback that are technically correct at a textual level but are poorly aligned with the actual cognitive and emotional states of learners during the lesson.

Furthermore, the absence of a standardized server-side architecture that transforms raw multimodal classroom data into well-structured input data and targeted prompt sentences for a generative AI model causes scalability and maintainability issues. Without such an architecture, it is difficult to automatically adapt output content for different user roles (for example, absent learners versus instructors) while systematically leveraging emotion indices, such as confusion, understanding, interest, and excitement, as computational signals. Existing implementations, when they attempt to provide feedback to instructors, tend to rely on ad hoc heuristics or manually defined rules and do not exploit large-scale generative models driven by rigorously constructed, context-rich prompts that embed emotion profiles.

Accordingly, there is a need for a computer-implemented system that improves how server-side processors acquire, synchronize, and process multimodal classroom data, generate emotion profiles in a time-series manner, and construct emotion-aware input data and prompt sentences for a generative AI model. By addressing these technical shortcomings in data acquisition, signal processing, feature fusion, and AI-driven text generation, the system can yield more accurate, context-sensitive summaries and feedback, thereby improving the functioning of the underlying computing infrastructure rather than merely automating a human mental process.

The specific processing by the specific processing unit 290 of the data processing device 12 in Example 2 is realized by the following means.

The present invention provides a server comprising a processor configured to receive, via a communication network, acoustic data and image data acquired in a classroom by a terminal device, to execute an acoustic recognition process on the acoustic data to generate character information representing uttered content, to execute an image analysis process on the image data to obtain character information representing contents written on a recording surface and to obtain facial expression information and posture information of persons included in the image data, to calculate emotional indices for respective time units based on acoustic feature quantities derived from the acoustic data and on the facial expression information and the posture information, to generate an emotion profile representing time-series emotional states along a lesson time axis, to integrate the character information generated by the acoustic recognition process, the character information representing the contents written on the recording surface, and the emotion profile into structured input data, to generate a prompt sentence including instructions that cause a generative artificial intelligence model to produce lesson summaries and feedback conditioned on the emotion profile, to input the structured input data and the prompt sentence into the generative artificial intelligence model to obtain summary information and feedback information reflecting the emotional indices, and to distribute the obtained summary information or the obtained feedback information to a user terminal. This enables a coordinated, server-centric processing architecture in which multimodal classroom data are time-synchronized, emotion-aware feature fusion is performed at scale, and generative AI-based text generation is driven by structured input data and dynamically constructed prompt sentences, thereby improving the accuracy, relevance, and computational efficiency of automated lesson summarization and feedback generation compared to conventional systems that treat audio, video, and generative models in an unintegrated or emotion-agnostic manner.

The term “system” refers to a combination of one or more hardware components and one or more software components that operate together to perform the functions described in the claims.

The term “processor” refers to a hardware computation unit, such as a central processing unit or a processing core, that executes instructions stored in a memory to perform data processing operations.

The term “acoustic data” refers to digital representations of sound signals acquired in a classroom, including, for example, utterances of instructors and learners.

The term “image data” refers to digital representations of optical images acquired in a classroom, including, for example, images of a recording surface and images of persons.

The term “acoustic acquisition unit” refers to a hardware and software combination configured to capture acoustic signals through one or more acoustic transducer elements and to output corresponding acoustic data.

The term “image acquisition unit” refers to a hardware and software combination configured to capture optical images through one or more imaging elements and to output corresponding image data.

The term “acoustic transducer element” refers to a device that converts sound waves into electrical signals, such as a microphone element.

The term “imaging element” refers to a device that converts optical images into electrical signals, such as an image sensor.

The term “terminal device” refers to an information processing apparatus located in or near a classroom that controls the acoustic acquisition unit and the image acquisition unit and transmits the acquired data to a server through a communication network.

The term “server side” refers to one or more information processing apparatuses that receive data from one or more terminal devices and execute server-side processing such as recognition, analysis, and generation.

The term “communication network” refers to a wired or wireless data communication infrastructure that enables transmission and reception of information between a terminal device and a server, and between a server and a user terminal.

The term “acoustic recognition process” refers to a computation process that analyzes acoustic data and outputs character information representing recognized speech content.

The term “character information” refers to textual data that represents symbols, words, sentences, or other linguistic units obtained by processing acoustic data or image data.

The term “recording surface” refers to a surface on which information is written or displayed during a lesson, such as a board, a display panel, or equivalent presentation medium.

The term “image analysis process” refers to a computation process that analyzes image data to detect or recognize objects, regions, or patterns and to extract information such as text, faces, or postures.

The term “facial expression information” refers to data indicating an estimated emotional or affective state of a person based on an analysis of facial features appearing in image data.

The term “posture information” refers to data indicating an estimated body orientation or pose of a person based on an analysis of body parts or skeleton structures appearing in image data.

The term “acoustic feature quantities” refers to numerical descriptors derived from acoustic data, such as energy, spectral characteristics, pitch, or other time-frequency features.

The term “emotional indices” refers to numerical values or sets of values representing estimated emotional states, including, for example, confusion, understanding, interest, and excitement, for corresponding time units.

The term “emotion profile” refers to a time-series representation of emotional indices along a time axis, indicating how estimated emotional states change over time during a lesson.

The term “structured input data” refers to data that organizes character information, recording-surface information, and emotion profile information in a predetermined format suitable for input to a generative model.

The term “prompt sentence” refers to an instruction sentence, question sentence, or specification text that is provided to a generative model to control or constrain the content and format of an output.

The term “generative artificial intelligence model” refers to a machine learning model that generates new text data based on input text data and a prompt sentence, and that includes a large-scale parameterized language model.

The term “summary information” refers to generated text data that concisely describes main points of a lesson and may include supplementary explanations based on an emotion profile.

The term “feedback information” refers to generated text data that provides analysis, suggestions, or guidance for improving lesson design or instruction, based at least in part on an emotion profile.

The term “user terminal” refers to an information processing apparatus operated by a learner, an instructor, or another user, and configured to receive and present summary information or feedback information distributed from a server.

The term “noise reduction process” refers to a computation process that suppresses or removes unwanted noise components from acoustic data while preserving desired speech components.

The term “directivity control process” refers to a computation process, such as beamforming, that adjusts sensitivity of acoustic transducer elements to enhance signals from a particular spatial direction and attenuate signals from other directions.

The term “signal processing algorithm” refers to a sequence of computational operations applied to acoustic data or other signals in order to transform, filter, or analyze the signals.

The term “main speaker direction” refers to an estimated spatial direction from which a dominant or primary speech signal originates within a classroom.

The term “transmission unit” refers to a hardware and software combination configured to send data from a terminal device to a server through a communication network.

The term “lesson” refers to an instructional session, such as a class or lecture, conducted within a classroom or equivalent environment.

The term “time unit” refers to a discrete time interval used for segmenting and analyzing acoustic data, image data, or emotion indices along a time axis.

The term “confusion index” refers to an emotional index that numerically indicates a degree of confusion or difficulty in understanding experienced by one or more learners.

The term “interest index” refers to an emotional index that numerically indicates a degree of interest or attention exhibited by one or more learners.

The term “excitement index” refers to an emotional index that numerically indicates a degree of liveliness or heightened engagement exhibited by one or more learners.

The term “predetermined threshold” refers to a predefined value used as a criterion for comparing an emotional index in order to determine whether the emotional index is relatively high or low.

The term “discussion contents” refers to text or conceptual information representing exchanges of opinions, questions, or answers among participants in a lesson.

The term “atmosphere” refers to contextual or qualitative aspects of a lesson, such as perceived engagement level or mood, that may be inferred from emotional indices and behavioral cues in the data.

In one embodiment, a system includes a terminal located in a classroom, a server connected to the terminal through a communication network, and one or more user terminals operated by learners and instructors. The terminal acquires multimodal classroom data using specific hardware components and transfers the acquired data to the server. The server executes a coordinated sequence of signal processing, recognition, analysis, data integration, and generative text production operations using software components and machine learning models. The user views generated outputs on the user terminal.

Terminal uses a processing unit, a memory, an audio acquisition device, an image acquisition device, and a communication interface. Terminal uses a plurality of acoustic transducer elements, such as condenser microphone elements, arranged as a microphone array. Terminal also uses an imaging module, such as an image sensor with a wide-angle lens, mounted to cover a classroom, including a recording surface and learners.

Terminal uses an operating system with an audio input/output stack, such as an Advanced Linux Sound Architecture or an equivalent audio subsystem, to open audio input channels for the microphone array. Terminal sets sampling parameters such as sampling frequency and quantization bits. Terminal allocates ring buffers for incoming audio samples. Terminal uses a signal-processing library such as a noise suppression library to perform frequency-domain noise estimation and suppression. Terminal converts time-domain audio samples into a short-time Fourier transform representation, applies a learned noise estimator network that outputs a gain mask per frequency bin, and applies the gain mask to suppress background components.

Terminal then reconstructs denoised samples using an inverse transform. Terminal uses a beamforming algorithm such as a delay-and-sum algorithm, in which terminal estimates a time delay between microphone channels for candidate arrival directions, aligns the signals according to the time delays, and sums them to emphasize the main speaker direction.

Terminal records, for each time window, the estimated main speaker direction as metadata associated with the denoised waveform.

Terminal uses an image-processing library such as a generic computer vision library to access the imaging element. Terminal sets frame resolution and frame rate, and acquires a continuous stream of frames. Terminal groups frames in fixed-duration segments. Terminal calls a video encoding component such as a generic video encoding library implementing H.264 or H.265 to compress the grouped frames. Terminal tags each compressed segment with a start time, an end time, and a class identifier in metadata. By performing noise reduction and beamforming on the terminal side and compressing video into smaller segments, the system reduces communication load and offloads some processing from the server, which contributes to improved system scalability and reduced end-to-end latency.

Terminal packages the denoised audio segments, estimated speaker-direction metadata, and compressed video segments into upload requests. Terminal uses an HTTP or HTTPS client library to send multipart requests to the server's upload endpoint. Terminal ensures that each request includes a class identifier, a room identifier, and time information so that the server can synchronize the streams.

Server uses one or more processing units, main memory, non-volatile storage, and a network interface. Server uses an application framework to implement network-facing interfaces and processing pipelines. Server stores received audio and video files in a storage subsystem, such as a file system or object storage. Server writes references to the stored files and metadata records into a data management system, such as a relational database. Server maintains tables for media records, transcripts, board text, emotion profiles, and generated outputs.

Server uses a speech recognition component to convert acoustic data into text. Server can use a neural network-based acoustic model combined with a language model. For example, server can use a sequence-to-sequence architecture with an encoder and decoder, where the encoder is built with convolutional layers and recurrent or transformer layers that process spectrogram features derived from the audio, and the decoder outputs character or subword tokens. Server first converts audio into mel-frequency spectrogram features, normalizes them, and feeds them into the encoder. Server uses a beam search algorithm in the decoder to find the most probable token sequence, conditioned on the acoustic features and an internal language model. Server can also integrate a separate speaker diarization model, such as a neural embedding extractor (for example, an x-vector network) and a clustering step, to segment the transcript by speaker. Server writes the resulting transcript as time-stamped segments containing fields such as start time, end time, speaker label, and text content.

Server uses a video analysis pipeline to process image data. Server uses a decoding library to convert compressed video into individual frames at a sampling interval. Server uses an object detection model, for example a convolutional neural network with region proposal or a one-stage detector, to detect a recording surface region and person regions. Server crops the recording surface region and applies an optical character recognition engine to extract text written on the surface. The OCR engine uses a convolutional-recurrent architecture: convolutional layers extract visual features from the cropped image, and recurrent layers decode sequences of characters. Server aggregates extracted board text over time and merges overlapping or repeated segments.

Server uses facial and posture analysis components to derive visual behavioral features. Server first uses a face detector network to locate faces in person regions. Server uses a facial expression classifier, which may be implemented as a convolutional network trained to output probabilities for expression classes such as neutral, confusion, joy, and concentration. Server computes, for each frame and for each detected face, an expression probability vector. Server also uses a pose estimation model, such as a keypoint detector based on a convolutional network, to infer body joint positions. Server derives posture descriptors, such as leaning forward, leaning backward, or upright, by computing angles between body joints. Server aggregates these per-face and per-frame features into time-window statistics, such as average confusion probability, proportion of learners leaning forward, and variance of head orientation.

Server constructs a multimodal feature representation per time unit. Server uses a signal-processing library to compute acoustic feature quantities from the denoised audio, such as mel-frequency cepstral coefficients, energy, spectral centroid, and pitch. Server aligns acoustic frames with the time windows used for visual features based on timestamps. Server constructs, for each time window, a vector that concatenates acoustic features with aggregated visual features. Server feeds each vector into a multimodal emotion recognition model. Server uses a multimodal neural network architecture to estimate emotion indices. In one embodiment, server uses an architecture including two subnetworks and a fusion layer. A first subnetwork processes acoustic feature sequences using a recurrent neural network, such as a bidirectional long short-term memory or a transformer encoder, and outputs a latent representation of acoustic dynamics. A second subnetwork processes visual features using a feedforward or recurrent network. A fusion layer concatenates or combines the two latent representations and passes them through fully connected layers to output emotion indices for confusion, understanding, interest, and excitement. Server trains this network using supervised learning on labeled classroom data, with a loss function such as mean squared error between predicted and ground-truth continuous emotion labels or cross-entropy loss for discrete emotion categories. Server updates network weights using gradient-based optimization, such as stochastic gradient descent or an adaptive optimizer, and may apply data augmentation methods like time stretching of audio and frame subsampling of video to improve robustness. Once trained, server executes the network in inference mode to generate an emotion profile for each lesson. Because the fusion network explicitly encodes correlations between acoustic patterns and visual behaviors along the same time axis, the system reduces misalignment errors and improves accuracy of emotion estimation compared to processing each modality separately.

Server stores the resulting emotion profile in the database as a time series aligned with the transcript and board text. Server defines a data structure for the emotion profile that contains an ordered list of time windows and, for each window, numerical values for emotional indices and pointers to related transcript and board segments. This structured representation allows efficient queries, such as identifying intervals where confusion exceeds a threshold or where interest and excitement are simultaneously high. By using such a structured data format, server reduces the computational cost of later analyses and simplifies operations for constructing targeted input for generative text models.

Server constructs input data for a generative AI model by integrating transcript text, board text, and emotion profile data. Server retrieves, for a given lesson, all transcript segments and board text segments. Server segments the lesson into logical parts, such as introduction, explanation, and discussion, by grouping time windows using rules based on changes in emotion indices or changes in speaker patterns. For each part, server creates a formatted text block that includes representative transcript excerpts, summarized board text, and summarized emotion indices. Server places identifiers or headings in the text, such as “Section 1: Introduction (00:00-10:00)” followed by key utterances and board notes, and then a short summary of confusion, understanding, interest, and excitement scores.

Server generates a prompt sentence tailored to the user type and desired output. For an absent learner, server may generate a prompt sentence such as:

“You are an educational summarization assistant.

The following information from a classroom lesson is provided:
1. A transcript of teacher and student utterances (excerpts).
2. Text recognized from the board or other recording surface.
3. Time-series emotion scores for the class (confusion, understanding, interest, excitement).

Using this information, create an output for a student who was absent from the lesson.

### Requirements:

Explain the main points of the entire lesson in about 5-10 sentences, in clear language appropriate for the learner's level.
For segments where the confusion score is above a specified threshold, provide a more detailed, step-by-step explanation of the corresponding content.
For segments where interest and excitement scores are high, describe the discussion content and classroom atmosphere so that the absent student can imagine how the discussion proceeded.
If the transcript includes any homework or preparation tasks, list them as bullet points.”

For an instructor, server may generate a prompt sentence such as:
“You are a lesson-improvement consultant.

Below is the record of a lesson, including transcript excerpts, board texts, and a time-series emotion profile (confusion, understanding, interest, excitement).

### Tasks:

1. Identify the segments where students were most confused and analyze possible reasons, based on the transcript, board contents, and emotion scores.
2. Propose multiple concrete ways to improve the explanation of those segments in future lessons, including changes in examples, pacing, or use of visual aids.
3. Identify the segments where interest and excitement were highest, explain what worked well in those segments, and propose how the instructor can generalize those strengths to other parts of the course.”

Server concatenates the structured input data with the generated prompt sentence to form an input context for a generative AI model. Server uses a generative artificial intelligence model, such as a large-scale language model with a transformer-based architecture. This language model uses self-attention layers and feedforward layers arranged in multiple blocks, with learned parameters for token embeddings, positional embeddings, and attention projections. Server sends the input text as a sequence of tokens to the model. Server configures model parameters such as maximum output length and sampling temperature to control the detail and variability of the generated text. Server receives the model's output tokens and decodes them to construct the summary information or feedback information.

Server processes the generative output further by splitting it into sections based on headings or markers, checking for completeness of requested items, and truncating or reformatting text if necessary. Server writes generated outputs to storage, associating them with lesson identifiers and user roles. Server then prepares distribution to user terminals.

Server uses a communication interface and a mail transfer component to send learner-oriented outputs via electronic mail. Server embeds the AI-generated summary and explanations into a pre-defined template that also includes lesson identifiers and links to more detailed content.

Server also uses a web application to serve instructor-oriented dashboards. The dashboard retrieves emotion profiles and AI-generated feedback via application programming interfaces and renders them as graphs and text segments. Server uses data visualization libraries to display time-series confusion, understanding, interest, and excitement along the lesson timeline, overlaid with markers for specific transcript or board events.

User interacts with the generated outputs through user terminals such as personal computers, tablets, or smartphones. When the user is a learner, the user reads the AI-generated summary to understand main points and focuses on the detailed explanations for high-confusion segments. The learner may decide to rewatch only specific parts of a recorded lesson corresponding to those segments, thereby saving time compared to watching the entire recording. When the user is an instructor, the user examines the emotion graphs to quickly locate the parts of the lesson where confusion was high or engagement was strong. The instructor reads the AI-generated suggestions and may adapt future materials accordingly. From a technical perspective, this configuration improves computer technology in several ways. Terminal performs specific noise reduction and beamforming operations before transmission, which reduces the signal-to-noise ratio burden on server-side recognition components and decreases network bandwidth usage. Server uses a coordinated multimodal feature fusion pipeline, in which acoustic and visual features are strictly aligned by time and encoded into a structured emotion profile data structure. This reduces redundant computation and enables efficient indexing and querying of time windows based on emotional indices. Server constructs prompt sentences that explicitly condition generative text on numerical emotion indices, rather than merely passing raw transcripts. This yields emotion-aware summaries and feedback that better reflect real classroom dynamics, improving the effectiveness of automated analysis compared to purely transcript-based summarization. Furthermore, server's use of a multimodal neural architecture for emotion estimation, with well-defined feature extraction, fusion, and trained weighting of modalities, provides technical advantages over naive rule-based systems. Because the model's parameters are optimized via gradient descent on labeled data with an explicit loss function, the model converges to weight combinations that minimize prediction error on emotion labels. This leads to higher accuracy in detecting confused segments, which in turn improves the relevance of generated explanations and feedback. The system's design of persistent data structures for transcripts, board text, and emotion profiles, and its coordinated use of those structures in constructing generative model inputs, also improves data management and reduces complexity of server-side code paths. Compared to a design in which each component processes files in an ad hoc manner, the described architecture reduces processing latency and error propagation between modules.

In addition, the described generative AI use is not limited to simple automation of human summarization. Server uses a non-conventional input representation that encodes fine-grained temporal emotion statistics and structural lesson segmentation into the prompt and context. The generative model thereby operates under a different set of rules than a human summarizer, for example, by systematically amplifying explanation detail in pre-identified confusion windows and compressing content in low-relevance windows according to emotion scores. This non-human, rule-driven conditioning, combined with specific numeric thresholds and fusion-based emotion estimation, yields a new class of machine-generated educational artifacts that would be difficult to replicate manually with the same consistency and scale.

Variations of the embodiment are possible. Terminal can, in another embodiment, perform partial speech recognition on-device for short segments to reduce server load, and server can merge on-device text with server-side recognition to improve accuracy. Server can also use alternative neural architectures for the generative AI model, such as encoder-decoder transformers or mixture-of-experts models. Server can, in some embodiments, incorporate additional modalities such as interaction logs from digital whiteboards or learning management systems by converting those into additional feature channels in the emotion recognition model. Server can vary the rules for constructing prompt sentences, for example, by incorporating instructor preferences regarding maximum summary length or preferred explanation styles, and server can store these preferences in configuration tables. Through these implementations, terminal, server, and user cooperate in a technically structured way, and the system as a whole achieves improved recognition accuracy, improved computational efficiency in multimodal processing, reduced communication load, and higher-quality, emotion-aware generative outputs, thereby improving the functioning of the underlying computer system rather than merely computerizing a manual workflow.

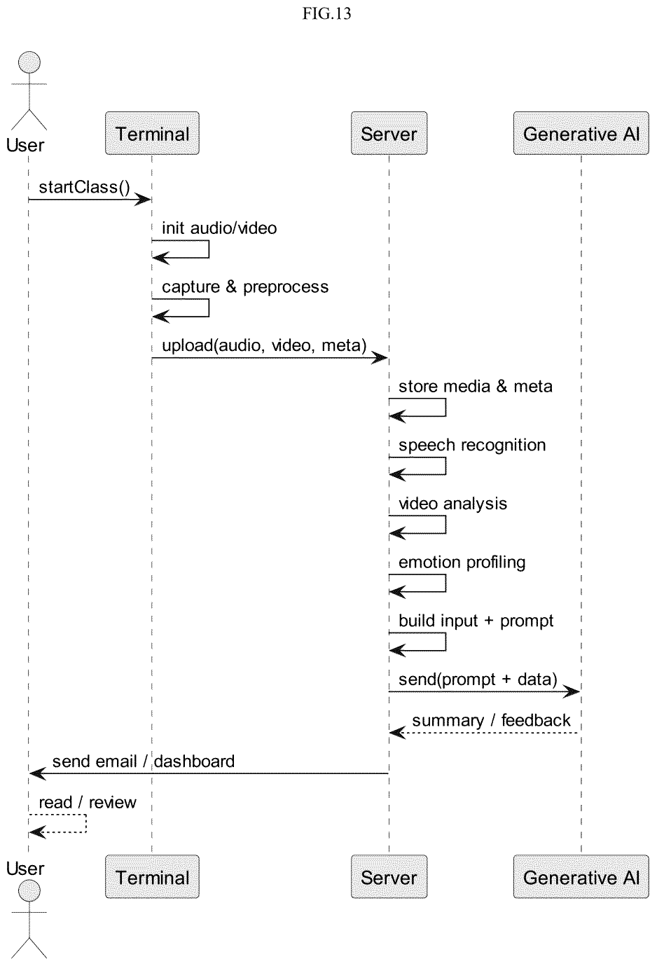

The following describes the processing flow using FIG. 13.

### Step 1:

Terminal initializes classroom sensors and acquisition parameters.

Terminal receives as input configuration data including class identifier, scheduled start time, sampling parameters, and camera parameters. Terminal uses an audio I/O subsystem (for example, an operating system audio API) to open input channels for a microphone array and sets sampling rate, bit depth, and channel count. Terminal allocates audio buffers in memory for continuous PCM sample storage. Terminal uses a vision library to open a camera device, sets resolution and frame rate, and allocates frame buffers. Terminal writes an internal state indicating that continuous acquisition of digital audio samples and image frames can be started, and outputs initialized audio and video acquisition contexts.

### Step 2:

Terminal captures raw audio and video signals from the classroom.

Terminal receives as input the initialized acquisition contexts from Step 1. Terminal reads analog sound picked up by the microphone array and converts it into PCM samples through an audio driver. Terminal stores successive blocks of PCM samples into audio buffers.

Terminal simultaneously acquires raw image frames from the camera at the configured frame rate and stores them into frame buffers. Terminal performs data acquisition only, without heavy processing, and outputs time-stamped raw audio sample sequences and raw image frame sequences.

### Step 3:

Terminal performs noise reduction and beamforming on audio data.

Terminal receives as input the time-stamped raw PCM audio sequences from Step 2. Terminal divides the audio stream into overlapping frames (for example, 20 ms with 50% overlap) and applies a short-time Fourier transform to each frame to obtain complex spectra. Terminal feeds the spectral magnitudes into a noise suppression model to estimate frequency-dependent gain values, multiplies the original spectra by the gain, and applies an inverse transform to reconstruct denoised time-domain frames. Terminal also applies a delay-and-sum beamforming algorithm across channels of the microphone array: terminal computes candidate time delays corresponding to different directions, shifts channel signals according to those delays, sums them, and calculates energy to determine a main speaker direction per time window. Terminal concatenates the denoised frames into a continuous denoised waveform and associates each time window with an estimated direction, and outputs denoised audio segments and direction metadata.

### Step 4:

Terminal encodes video into compressed segments with metadata.

Terminal receives as input the raw image frame sequence from Step 2. Terminal groups frames into fixed-duration intervals (for example, 10 seconds of frames). Terminal calls a video encoder to compress each group of frames using a configured codec (for example, H.264 or H.265) and target bitrate. Terminal wraps encoded video packets into a container format file and writes metadata including start timestamp, end timestamp, and class identifier.

Terminal outputs a set of compressed video files, each associated with a time range and class metadata.

### Step 5:

Terminal packages multimodal data and transmits them to the server.

Terminal receives as input the denoised audio segments with direction metadata from Step 3 and the compressed video files with associated metadata from Step 4. Terminal creates a data structure containing class identifier, room identifier, start and end times, and any speaker-direction statistics. Terminal constructs an HTTP or HTTPS multipart request, attaches audio files, video files, and a metadata field serialized as text. Terminal sends the request through a communication interface over a network to a predefined server upload endpoint. Terminal waits for an acknowledgment and outputs a transmission result including success/failure status and any server-assigned media identifiers.

### Step 6:

Server receives uploaded media and registers them in persistent storage.

Server receives as input the HTTP or HTTPS request from Step 5 containing audio files, video files, and metadata. Server validates the request, extracts files, and writes them to a storage subsystem (for example, file system paths or object storage URIs). Server parses the metadata to obtain class identifier, room identifier, and time range. Server creates database records that link each stored file path with the corresponding class identifier and timestamps and sets processing status flags such as “pending_transcription” and “pending_video_analysis.” Server outputs media records with unique identifiers and updated processing status.

### Step 7:

Server performs speech recognition and generates a time-stamped transcript.

Server receives as input the stored audio file paths and metadata from media records flagged as “pending_transcription” from Step 6. Server loads each audio file, normalizes amplitude, and optionally re-segments long recordings into shorter chunks. Server converts audio chunks into spectrogram features and feeds them into a neural network-based speech recognition engine. Server decodes the model's output token probabilities using a search algorithm to obtain textual content, and aligns recognized tokens with time offsets. Server optionally runs a speaker diarization model on the same audio to partition the audio into segments associated with different speakers and labels segments as instructor or learner where possible. Server merges all recognized segments in chronological order into a transcript that includes, for each segment, start time, end time, speaker label, and recognized text. Server stores the transcript in the database and sets the audio processing status to “transcribed,” and outputs transcript records associated with class identifiers.

### Step 8:

Server analyzes video to extract board text and learner behavior.

Server receives as input the stored video file paths and their metadata from media records flagged as “pending_video_analysis” from Step 6. Server decodes compressed video into frames at a predetermined sampling interval. Server applies an object detection model to each frame to locate a recording surface region and person regions. Server crops the recording surface region and applies an optical character recognition engine to obtain textual content such as formulas, key terms, or assignments. Server accumulates recognized board text over time, merges overlapping detections, and associates each text segment with a time interval.

Server also processes person regions: server detects faces, applies a facial expression classifier to estimate expression probabilities (for example, confusion, neutral, joy), and applies a pose estimator to quantify posture (for example, leaning forward or backward).

Server aggregates expression and posture data over fixed time windows to compute statistics such as average confusion probability and proportion of learners leaning forward. Server stores board text records and behavior statistics in the database and sets the video processing status to “video_analyzed,” and outputs time-indexed board text and visual behavior feature records.

### Step 9:

Server extracts multimodal features and computes an emotion profile.

Server receives as input the audio data or denoised audio file references from Step 6 or Step 7 and the visual behavior feature records from Step 8. Server uses a signal-processing library to compute acoustic feature vectors (for example, mel-frequency cepstral coefficients, energy, spectral centroid, pitch) in short time frames across the lesson duration. Server aligns acoustic frames to the same time windows used for visual statistics using timestamps. Server aggregates acoustic features within each time window (for example, by averaging or pooling) and concatenates them with visual features such as mean expression probabilities and posture ratios to form multimodal feature vectors. Server feeds these vectors, in time order, into a trained multimodal neural network that outputs for each time window numerical emotion indices for confusion, understanding, interest, and excitement. Server collects these outputs and constructs an ordered list of time windows with associated emotion indices, forming an emotion profile. Server stores the emotion profile in the database and outputs a structured emotion profile linked to the class identifier.

### Step 10:

Server constructs structured input data and a prompt sentence for a generative AI model.

Server receives as input the transcript records from Step 7, the board text records from Step 8, and the emotion profile from Step 9. Server retrieves all segments for a given class and organizes them along the timeline. Server groups consecutive time windows into logical sections, for example, introduction, explanation segments, and discussion segments, based on changes in speaker patterns or emotion indices. Server for each section selects representative transcript excerpts, merges relevant board text, and summarizes the emotion indices as simple descriptions or numeric summaries. Server concatenates these section blocks into a structured text, including headings and time ranges. Server then generates a prompt sentence specifying tasks for the generative AI model; for a learner, server may include instructions to summarize main points and provide additional explanation for time windows where confusion index exceeds a threshold; for an instructor, server may include instructions to identify confusing segments and propose improved teaching strategies. Server outputs a combined input consisting of the structured class data text and the prompt sentence.

### Step 11:

Server calls the generative AI model and obtains summary and feedback text.

Server receives as input the combined structured text and prompt sentence from Step 10.

Server tokenizes this input into a sequence of token identifiers according to the vocabulary used by a generative AI model and sends the tokens to the model via an internal or external model interface. Server configures model generation parameters such as maximum token count and sampling temperature. Server executes the model to compute attention-based hidden representations across layers and generate output token probabilities step by step, selecting tokens according to the configured decoding strategy. Server concatenates the generated tokens into output text, which includes summary information or feedback information tailored to the described tasks. Server may parse headings or markers in the generated text to split it into sections such as “Lesson Summary,” “Explanations of Difficult Parts,” and “Suggestions for Improvement.” Server stores the generated text in the database associated with the corresponding class and user role, and outputs finalized summary and feedback documents.

### Step 12:

Server formats outputs for distribution and sends them to user terminals.

Server receives as input the generated summary and feedback documents from Step 11 and user information records indicating which learners were absent and which instructor is responsible for the class. Server constructs learner-facing messages by embedding the summary text and explanations into an email template, inserting class identifiers, dates, and optional links to additional resources. Server constructs instructor-facing data structures for a dashboard page, combining emotion time series, key board text, transcript excerpts, and feedback text in a structured format such as JSON for front-end rendering. Server sends emails via a mail transfer component to learner addresses and updates dashboard-related records accessible through web endpoints. Server outputs confirmation of successful dispatch or error logs for any failed transmissions.

### Step 13:

User accesses and utilizes the generated information for learning and teaching.

User receives as input the summary and feedback that server distributed in Step 12. When the user is a learner, the user opens an email client on a user terminal, loads the message body, and reads the summary and detailed explanations. Based on the text, the learner identifies lesson sections that need focused review and may follow provided links to view additional material. When the user is an instructor, the user opens a web browser on a user terminal, accesses a dashboard page, and views graphs that plot confusion, understanding, interest, and excitement indices over time, along with AI-generated textual analysis. The instructor uses this information to adjust lesson plans or create new teaching materials. In both cases, the user's actions are driven by the structured, emotion-aware outputs generated by the server, closing the loop between classroom data acquisition and improved educational practice.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems that record and analyze audio and video in human-human interaction environments, such as educational or care settings, typically process each modality in isolation and generate simple summaries based mainly on transcribed text. Such systems suffer from multiple technical limitations in terms of computer technology itself.

First, known audio recording and analysis pipelines generally perform speech recognition on continuous audio streams without robust segmentation, multimodal alignment, or context-aware speaker labeling. As a result, the generated text data often lacks reliable time alignment, speaker roles, and utterance-type distinctions. This degrades the performance of downstream automatic processing, including summarization by a generative AI model, and forces additional manual review.

Second, conventional video analysis subsystems frequently treat video data only as visual context or for basic detection (for example, presence/absence of a person), without tightly integrating posture, behavior, and facial expression features with synchronized audio and text data. Because of this lack of multimodal fusion at the data-structure and processing-pipeline levels, the computer system cannot accurately estimate a subject's emotional state or track changes in emotional state over time, and therefore cannot perform reliable, context-sensitive evaluation of interactions.

Third, existing systems that call a generative AI model usually send raw or lightly processed text to the model. They do not automatically construct structured prompt sentences that encode: (i) speaker roles, (ii) identified instruction utterances, (iii) subject-condition-related utterances, (iv) time-aligned behavior labels, and (v) quantitative emotional state scores. Without such structured prompts, the generative AI model often produces outputs that are inconsistent, incomplete, or not traceable back to specific time segments in the original multimodal data, reducing the technical reliability and reproducibility of the system.

Fourth, conventional alert mechanisms in such systems are generally threshold-based on simple single-channel metrics (for example, volume level or keyword detection), and are not driven by integrated, time-series emotional state estimations and model-generated evaluation information. As a consequence, the computer system either generates too many false alerts or fails to detect important abnormal patterns in emotional changes that correlate with specific behaviors or instructions, leading to inefficient use of computational and human resources. Accordingly, there is a need for a computer-implemented system that technically improves the way a processor: (i) acquires and preprocesses audio and video data with time and identification metadata, (ii) performs multimodal analysis combining speech recognition, speaker and utterance-type classification, posture and facial expression extraction, and time-series emotion estimation, (iii) automatically constructs and manages structured prompt sentences for a generative AI model, and (iv) generates evaluation and alert information based on integrated multimodal and model-derived data. Such a system should improve the accuracy, robustness, and efficiency of computer-based analysis and alerting, while reducing manual intervention in data review and interpretation.

The specific processing by the specific processing unit 290 of the data processing device 12 in Application Example 2 is realized by the following means.

The present invention provides a server comprising a processor configured to acquire and record audio data and video data from an environment together with time information and identification information, to segment and compress the audio data and the video data into preprocessed data units, to perform acoustic analysis and language analysis on the audio data so as to generate time-aligned text data including speaker information and utterance-type information, to perform image processing and pattern recognition on the video data so as to extract, in association with the time information, multimodal feature information including posture information, behavior information, and facial expression information of a subject, to integrate acoustic feature information and the text data with the multimodal feature information in a time-series manner and estimate, by executing an emotion estimation algorithm, an emotional state of the subject and a change in the emotional state over time, to analyze the integrated data in order to automatically extract and classify instruction utterances directed to the subject and utterances relating to a condition of the subject, to generate a structured prompt sentence including the extracted utterances, the behavior information, and the emotional state, to transmit the structured prompt sentence to a generative AI model and obtain, from the generative AI model, response information including summary information, important utterance information, and evaluation information, to evaluate predefined alert conditions based on the estimated emotional state and the evaluation information so as to generate alert information when an abnormal emotional change or behavior-related problem is detected, and to store and provide presentation data including the summary information, the important utterance information, the evaluation information, and the alert information to a user terminal. This enables improved computer-implemented multimodal analysis and control by allowing the server to automatically construct rich, context-aware prompt sentences for a generative AI model, to obtain more accurate and explainable summaries and evaluations, to reduce processing errors associated with unstructured or unimodal inputs, and to generate reliable, time-aligned alert information based on integrated audio, video, and emotion data, thereby enhancing the technical performance and efficiency of the overall information processing system.

The term “audio data” refers to digital data representing sound signals acquired from an environment, the sound signals including utterances of one or more persons and optionally environmental sounds, which are obtained by sampling and quantizing analog audio signals from at least one audio input device.

The term “video data” refers to digital data representing image signals acquired from an environment, the image signals including one or more frames or sequences of frames showing at least one subject, which are obtained from at least one imaging device.

The term “time information” refers to information indicating temporal positions or time ranges, including absolute times or relative times, associated with audio data, video data, and derived analysis results, and used to align and correlate multimodal data elements along a timeline.

The term “identification information” refers to information that identifies at least one of a recording device, a subject, a session, a location, or a data segment, and that is associated with audio data, video data, or analysis results for management and retrieval.

The term “preprocessed data” refers to audio data and video data that have been subjected to at least one processing operation including segmentation, removal of silent sections, noise reduction, or compression, and that are stored in a form suitable for subsequent analysis.

The term “acoustic analysis” refers to processing applied to audio data to extract acoustic feature information, including at least one of loudness, pitch, speaking rate, prosody, and spectral characteristics, which is used in speech recognition or emotion estimation.

The term “language analysis” refers to processing applied to audio data or text data to convert speech into text, and to interpret linguistic content, including at least one of tokenization, part-of-speech tagging, syntactic parsing, and semantic analysis.

The term “text data” refers to character-based or token-based data representing the linguistic content of utterances obtained from audio data by speech recognition or other language processing, and including associated metadata such as speaker information and time information.

The term “speaker information” refers to information indicating at least which person produced a given utterance, including a label distinguishing different speakers, such as a subject and another participant, and optionally a role, such as an instructor, caregiver, or user.

The term “utterance-type information” refers to classification information indicating a functional category of an utterance, including at least one of an instruction, an explanation, a confirmation, a question, or a casual remark.

The term “speaker separation” refers to processing that segments and groups portions of audio data or text data by speaker, and assigns each utterance to one of a plurality of speaker identities or roles based on acoustic and contextual features.

The term “image processing” refers to computational operations performed on video data or image frames, including at least one of filtering, distortion correction, object detection, region extraction, and tracking, to prepare or transform visual data for further analysis.

The term “pattern recognition” refers to computational analysis applied to audio data or video data to identify or classify patterns, including at least one of posture patterns, movement patterns, facial expressions, or other behavior patterns of a subject.

The term “feature information” refers to numerical or symbolic data extracted from audio data or video data, including at least one of acoustic features, posture features, behavior labels, facial expression scores, or other derived descriptors used for subsequent analysis.

The term “posture information” refers to feature information that characterizes a body configuration of a subject, including at least one of joint positions, body orientation, or posture labels such as sitting, standing, walking, or lying.

The term “behavior information” refers to feature information that characterizes an action or operation performed by or on a subject, including at least one of assistance actions, gestures, or movement sequences, and corresponding time ranges.

The term “facial expression information” refers to feature information derived from visual analysis of a subject's face, including at least one of probabilities, scores, or labels corresponding to emotion-related facial expressions such as joy, anxiety, pain, confusion, or neutrality.

The term “multimodal feature information” refers to a set of features obtained by combining audio-based, video-based, and text-based data, including acoustic features, language features, posture features, behavior features, and facial expression features, aligned in time.

The term “emotional state” refers to information representing a psychological or affective condition of a subject at a given time, including at least one category such as calm, anxious, angry, confused, fatigued, or in pain, and optionally including a numerical intensity value for each category.

The term “emotion estimation algorithm” refers to a computational procedure, including at least one of a machine learning model or a rule-based model, which receives multimodal feature information as input and outputs an estimation of an emotional state and changes in the emotional state over time.

The term “instruction utterance” refers to an utterance directed to a subject that conveys a request, command, guidance, or procedure to be followed by the subject.

The term “utterance relating to a condition of the subject” refers to an utterance in which the subject or another person describes, reports, or refers to a physical, mental, or situational condition of the subject, including at least one of discomfort, symptoms, or functional status.

The term “prompt sentence” refers to text data constructed to be input to a generative AI model, the text data including instructions, constraints, contextual information, and structured content derived from multimodal analysis, and specifying a desired processing task or output format.

The term “generative AI model” refers to an artificial intelligence model that has been trained using machine learning to generate new text or other content based on input text data, and that can produce outputs such as summaries, classifications, evaluations, or recommendations in response to a prompt sentence.

The term “summary information” refers to information generated from detailed data by reducing and organizing content to highlight main points or key events, including at least a concise representation of instructions, interactions, or episodes extracted from the text data.

The term “important utterance information” refers to information specifying utterances that are determined, by analysis or by a generative AI model, to be significant with respect to a condition, event, or evaluation target, and including at least time information and content of the utterances.

The term “evaluation information” refers to information indicating an assessment or analysis result generated on the basis of multimodal data and outputs of a generative AI model, including at least one of qualitative comments, numerical scores, or categorizations regarding interactions, behaviors, or conditions.

The term “alert condition” refers to a predefined logical condition evaluated using estimated emotional states, behavior information, and evaluation information, the condition specifying criteria for detecting an abnormal emotional change, a deteriorating trend, or a behavior-related problem.

The term “alert information” refers to information generated when an alert condition is satisfied, the information including at least an identification of a relevant behavior type, an associated time period, and related utterance contents, and optionally including recommended responses.

The term “presentation data” refers to data prepared for output to a user terminal, including formatted summary information, important utterance information, evaluation information, and alert information, in a structure suitable for display in graphical, textual, or tabular forms.

The term “user terminal” refers to an information processing device operated by a user, including at least one of a personal computer, a portable terminal, or a tablet device, configured to receive presentation data from the server and to present the data on a user interface.

In the following embodiments, a terminal, a server, and a user cooperate to implement the claimed system. The embodiments are examples only and do not limit the scope of the invention.

### 1. System Architecture and Hardware/Software Configuration

The terminal is implemented as an embedded information processing device installed in an environment where human interaction occurs, such as a room, corridor, or shared space. The terminal includes at least one processor, a memory, an audio input device, an imaging device, and a wireless communication interface. The terminal executes an embedded operating system, for example a general-purpose embedded Linux operating system, and one or more application programs that perform audio acquisition, video acquisition, preprocessing, and transmission.

The server is implemented as an information processing apparatus installed on-premises or in a cloud computing environment. The server includes at least one central processing unit, a main memory, a non-volatile storage system such as a magnetic disk or solid-state drive, and a network interface. The server executes a server-class operating system, for example a general-purpose server operating system, and server applications implemented using a web application framework, for example a framework of the type of Django, Flask, or a Node.js-based framework. The server further uses a relational database management system such as a system of the type of PostgreSQL or MySQL, an object storage system such as a system of the type of network-attached storage or cloud object storage, and an asynchronous job queue system such as a system of the type of Celery with a message broker.

The user operates a user terminal such as a personal computer, tablet device, or smartphone.

The user terminal executes a web browser, for example a browser of the type of Google Chrome, Microsoft Edge, or Safari, and accesses a web application provided by the server.

### 2. Audio and Video Acquisition and Preprocessing in the Terminal

The terminal uses the audio input device, for example a high-sensitivity microphone or a microphone array, controlled through an operating system sound driver such as a general-purpose ALZA-type driver, to sample and quantize analog audio signals at a predetermined sampling rate and bit depth. The terminal stores sampled audio frames in a ring buffer in the memory.

The terminal uses an audio processing library, for example a library of the type of FFmpeg and a noise suppression library, to perform noise reduction on the audio frames. In one embodiment, the terminal uses a spectral subtraction algorithm or a Wiener filter implemented in the library to attenuate stationary background noise. In the case of a microphone array, the terminal uses a sound source localization algorithm such as a generalized cross-correlation phase transform method to estimate azimuth directions of sound sources. The terminal then forms beamforming filters to emphasize audio coming from at least two directions corresponding to a primary subject and another participant.

The terminal uses the imaging device, for example a camera module with a wide-angle lens, controlled through a video input driver such as a Video4Linux-type driver, to acquire successive image frames at a predetermined frame rate. The terminal uses an image processing library, for example OpenCV, to apply lens distortion correction and basic filtering such as Gaussian blur and brightness normalization to each frame.

The terminal associates time information, for example timestamps obtained from a system clock, with each block of audio data and video data, and associates identification information such as a terminal identifier, a session identifier, and a location identifier. The terminal divides the continuous audio data into segments of a predetermined duration, for example 5 seconds to 30 seconds, and applies a voice activity detection algorithm. In one embodiment, the terminal uses an energy-based VAD combined with a zero-crossing rate threshold to classify frames as speech or non-speech, and removes non-speech segments, thereby reducing data volume and improving subsequent recognition accuracy.

The terminal encodes the resulting speech segments using an audio codec such as a codec of the type of Opus or AAC to generate compressed audio files. The terminal encodes the video frames using a video compression method such as a method of the type of H.264/AVC or H.265/HEVC, or encodes selected frames as JPEG images for key frames. The terminal generates preprocessed data including the compressed audio files, compressed video files, and corresponding metadata formatted in a structured text format such as JSON or XML. This preprocessing in the terminal reduces communication bandwidth requirements and storage capacity requirements, thereby providing a technical effect on communication load reduction and data management efficiency.

### 3. Data Transmission and Storage

The terminal uses a communication library such as an HTTP client library based on TCP/IP to establish a secure session with the server using a secure protocol such as HTTPS over TLS.

The terminal transmits the preprocessed data to an upload endpoint provided by the server's web application. The terminal receives an HTTP status code from the server; in the case of a success code, the terminal marks the corresponding data as transmitted in a local transmission status table. In the case of a failure code or timeout, the terminal registers the corresponding data in a retransmission queue and performs exponential backoff in retransmission timing.

The server uses its web application framework to implement an upload controller that receives HTTP POST requests containing multipart form data or structured payloads. The server stores received audio files and video files in an object store and registers file paths and metadata in database tables. The server enqueues analysis tasks referencing the registered session records in an asynchronous job queue.

By separating acquisition, preprocessing, and transmission at the terminal from heavy analysis at the server, the system distributes computation appropriately and improves overall system throughput and scalability.

### 4. Speech Recognition, Speaker and Utterance-Type Analysis

The server uses an audio analysis worker program implemented, for example, in Python to process audio analysis tasks. The server loads a speech recognition model from storage. In one embodiment, the server uses a neural network-based automatic speech recognition model such as a transformer-based encoder-decoder or a connectionist temporal classification model of the type of Whisper or wav2vec 2.0, implemented in a deep learning framework such as PyTorch or TensorFlow.

The server first computes acoustic features such as Mel-frequency cepstral coefficients and log-Mel spectrograms from the audio data using a library such as librosa. The server feeds the acoustic features into the trained ASR model. The ASR model includes multiple layers of self-attention and feed-forward networks, with learned weights that map sequences of acoustic feature vectors to sequences of text tokens. During inference, the server uses beam search decoding or greedy decoding to generate the most likely text token sequence along with time alignments.

The server groups tokens into utterances based on pause durations, sentence boundaries, or punctuation inferred by the language model, and associates each utterance with start and end timestamps. The server performs speaker separation by computing speaker embeddings such as x-vectors or d-vectors from acoustic segments and clustering them using an algorithm such as agglomerative hierarchical clustering. The server uses direction information from the terminal to constrain the clustering and assigns each utterance to a speaker label corresponding to a subject or another participant.

The server optionally applies a text classification model, for example a transformer-based model of the type of BERT fine-tuned on utterance-type labels, to classify each utterance as an instruction, explanation, confirmation, question, or casual remark. These classifications are stored as utterance-type information in the database.

This combination of time-aligned ASR, speaker separation, and utterance-type classification produces structured text data that is richer than a simple transcript and improves the precision and recall of downstream extraction and summarization.

### 5. Video Analysis: Posture, Behavior, and Facial Expression

The server uses a video analysis worker program to process video analysis tasks. The server loads a person detection model, a pose estimation model, and a facial expression classification model.

In one embodiment, the server uses a convolutional neural network-based object detector of the type of YOLO or Faster R-CNN to detect person regions in each frame. The detector receives image tensors as input and outputs bounding boxes, class scores, and confidence scores. The server extracts image patches for detected persons and performs face detection using a face detection network such as a multi-task convolutional network.

The server uses a pose estimation model such as a model of the type of OpenPose or a lightweight HRNet-based network to estimate body keypoints of the subject. The server converts joint coordinates into posture features and assigns posture labels such as “sitting,” “standing,” “walking,” “standing-up,” or “lying” using a classifier trained on keypoint configurations. The server detects behavior events by analyzing sequences of posture labels over time using a finite-state machine or a temporal convolutional network.

The server applies a facial expression classifier, implemented as a convolutional or transformer-based network trained on facial expression datasets, to cropped face images of the subject. The classifier outputs probability scores for multiple expression categories such as joy, relief, anxiety, pain, confusion, and neutral. The server records, for each frame, posture features, behavior labels, and facial expression scores together with time information.

By generating posture and emotion features at the server using trained models and aligning them with text and audio, the system produces a multimodal feature representation that supports more accurate emotion estimation and evaluation than purely text-based systems.

6. Emotion Estimation from Multimodal Time-Series

The server uses an emotion analysis worker program to estimate an emotional state of the subject over time. The server first extracts acoustic emotion features such as pitch contours, energy trajectories, speaking rate, and prosody measures from the subject's speech segments using a library such as librosa or pyAudioAnalysis. The server aligns acoustic features with posture and facial expression features using their timestamps.

The server constructs, for each time step, a multimodal feature vector that concatenates acoustic features, posture features, behavior labels encoded as one-hot or embedding vectors, and facial expression scores. The server then feeds sequences of these feature vectors into an emotion estimation model.

In one embodiment, the emotion estimation model is implemented as a recurrent neural network, for example a bidirectional long short-term memory network with attention, or a transformer-based time-series encoder. The network has an input layer that receives the multimodal feature vectors, multiple hidden layers that learn temporal dependencies, and an output layer that produces probability distributions over emotion categories such as calm, anxious, angry, confused, fatigued, and in pain at each time step.

The server trains the emotion estimation model offline using supervised learning with labeled examples. Training uses a loss function such as cross-entropy between predicted emotion distributions and ground truth labels, and the server updates the model's weights using a gradient-based optimizer such as Adam. Training data may be augmented by adding noise to audio features, temporal warping of sequences, or mirroring of pose coordinates to improve robustness.

During operation, the server executes the trained model in inference mode only. The server obtains, for each time point, an emotional state label and a numerical score. The server aggregates scores over time windows, computes moving averages, and compares them to baselines stored per subject. This enables detection of sustained elevation of anxiety or pain and reduces noise-related false positives.

This architecture improves computer technology by enabling efficient, time-aligned fusion of multiple sensor modalities within a single model, reducing the need for manual rule-based heuristics and increasing accuracy and stability relative to unimodal or static approaches.

7. Construction of Structured Prompt Sentences and Interaction with the Generative AI Model

The server uses a natural language processing module to convert the structured multimodal data into a prompt sentence suitable for input to a generative AI model.

The server first filters utterances to identify instruction utterances directed to the subject and utterances describing the subject's condition, based on the utterance-type information and simple lexical rules such as presence of verbs expressing commands or reports of symptoms.

The server also selects periods where behavior labels indicate specific actions, such as standing-up assistance, and where emotion scores exceed a threshold or change rapidly.

The server then constructs a structured prompt sentence in natural language that encodes: (i) the conversation log with speaker labels and timestamps, (ii) the emotional state labels and scores at corresponding times, and (iii) summaries of behavior labels and posture changes.

The server uses a template-based generator: a programmatic template defines sections of the prompt sentence, and the server fills placeholders with extracted text snippets, numerical scores, and labels.

For example, when the server requests summarization of caregiver instructions, the server may generate a prompt sentence similar to:

“Below is a transcript of a conversation between a caregiver and a care recipient in a care facility, together with emotion estimation results.
1. Conversation log (with speaker labels: caregiver/care recipient, and timestamps)
2. For each timestamp, the care recipient's emotion labels (such as calm, anxious, confused, in pain) and scores.

Based on this information, extract only the instructions given by the caregiver to the care recipient, and summarize them in chronological order as bullet points.

Additionally, briefly describe how the care recipient's emotions changed before and after each instruction.”

When the server requests extraction of important health-related statements, the server may generate a prompt sentence similar to:

“Using the following conversation log and emotion estimation results, extract important statements made by the care recipient regarding their health condition or physical discomfort, such as pain, shortness of breath, inability to sleep, or loss of appetite.

Organize these statements by category, and place particular emphasis on segments where terms like ‘pain’, ‘short of breath’, ‘can't sleep’, or ‘no appetite’ occur together with high scores for emotions such as pain, anxiety, or fatigue.”

When the server requests care evaluation and improvement suggestions, the server may generate a prompt sentence similar to:

“The input data are:
1. Caregiver action analysis results (labels and times for actions such as standing-up assistance, walking assistance, and repositioning)
2. Care recipient emotion estimation results (time-series data for emotions such as calm, anxiety, and pain)
3. A summary of the conversation log.

Using these data, evaluate the quality of care provided by the caregiver. In particular, identify situations where the care recipient's anxiety or pain increases sharply in response to specific caregiver actions or instructions. For each such situation, explain possible reasons and provide concrete suggestions for improvement.”

The server sends the prompt sentence and necessary context data to a generative AI model via an application programming interface. The generative AI model is, for example, a large language model implemented as a multi-layer transformer network pre-trained on large text corpora and optionally fine-tuned for summarization and classification tasks. The server specifies, in the API call, parameters such as maximum output length, temperature, and formatting instructions.

The server receives a response text from the generative AI model that contains, for example, a list of instruction summaries, a list of important health-related statements, evaluation comments, and recommendations. The server parses this response using simple delimiters, headings, or pattern matching and converts it into structured data fields such as summary information, important utterance information, and evaluation information.

By programmatically constructing rich, structured prompt sentences and parsing outputs into machine-readable structures, the server improves utilization of the generative AI model as a computational component, resulting in higher consistency and traceability of outputs compared to systems that send unstructured text.

### 8. Alert Generation and Technical Effects

The server evaluates alert conditions using the time-series emotional state data and evaluation information. The server implements alert conditions as logical expressions over numerical emotion scores, derivatives of scores (rate of change), and behavior labels. For example, a condition may be defined such that if an anxiety score remains above a threshold for a specified number of consecutive time windows during a particular behavior, an alert is triggered. Another condition may be defined such that if a pain score increases by more than a predetermined delta within a short time window during a specific assistance action, an alert is triggered.

The server computes these conditions efficiently by pre-aggregating emotion scores in time buckets and storing them in indexable database tables. The server then executes SQL queries or in-memory evaluations using vectorized operations in a numerical library to detect patterns. When an alert condition is satisfied, the server generates alert information including the behavior type, the relevant time period, associated utterance contents, and optionally a brief explanation derived from evaluation information.

The server stores alert information and associates it with the subject and session identifiers.

The server provides presentation data that includes alerts in combination with graphs of emotional trends and key utterances. The user uses the user terminal to access this data, and the server renders visualizations, for example using a charting library in the web application. Because the system uses multimodal, time-series emotion estimation and structured AI-generated evaluation in combination for alerting, false positives caused by transient noise or isolated utterances are reduced, and alerts are more tightly coupled to genuine abnormal states. This constitutes an improvement in the technical functioning of the alert subsystem.

9. Technical Advantages and Compliance with Patent-Eligibility Guidelines

The terminal and the server do not merely implement a mental process or manual workflow on a computer. The terminal performs concrete signal processing operations, such as beamforming, noise reduction, and video compression, using specialized libraries and drivers, thereby reducing communication load and enabling deployment in bandwidth-limited environments.

The server implements specific data structures—time-aligned utterance objects with speaker and utterance-type fields, posture and expression feature vectors, and multimodal feature sequences—that are not present in conventional text-only summarization systems. The server uses non-conventional processing flows: it first fuses multimodal features via a trained neural architecture, then automatically constructs structured prompt sentences tailored to the fused data, and only then invokes the generative AI model. This ordering and combination of steps changes how the computer processes, stores, and routes data, leading to measurable improvements in recognition accuracy, summarization relevance, and alert reliability.

The emotion estimation network architecture and its training procedure, including the choice of multimodal input features, loss function, and sequence modeling structure, improve the computer's ability to automatically infer temporal affective patterns from noisy sensor data, which is not a mere automation of human judgment. The use of time-aligned multimodal features and training with augmented data leads to robustness against missing modalities and sensor noise, thereby improving system reliability.

By designing the generative AI interaction around explicit, machine-generated prompt sentences that embed structured temporal and emotional context, the server reduces the computational expense of iterative, trial-and-error prompting and lowers the total number of remote calls to the generative AI model. This produces a technical effect on processing speed and resource utilization, particularly in environments where API calls incur latency and cost. The combined result is a system in which the terminal and the server cooperate to perform improved, computer-centric processing of sensor data and language data, enabling faster, more accurate, and more efficient multimodal analysis, summarization, and alerting, beyond what is achievable by conventional isolated ASR, video analysis, or generic text summarization alone.

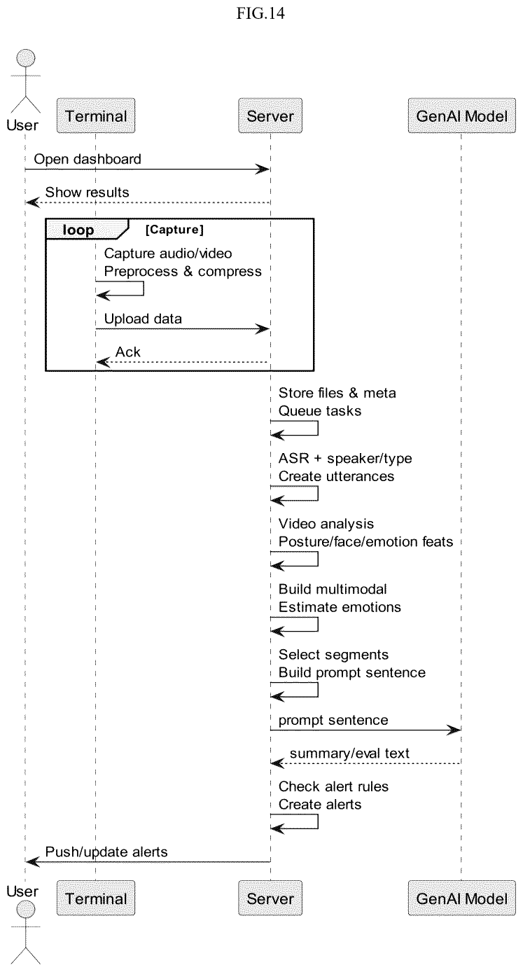

The following describes the processing flow using FIG. 14.

### Step 1:

The terminal acquires raw audio and video.

The terminal uses the audio input device (for example, a microphone array) and the imaging device (for example, a camera module) as inputs. The terminal controls these devices through operating system drivers to continuously sample analog audio signals and capture image frames. The terminal converts the analog audio to digital samples by performing sampling and quantization, and stores the samples in a ring buffer in memory. The terminal stores each captured frame as a digital image in a frame buffer. As output, the terminal produces raw audio sample streams and raw video frame sequences annotated with initial timestamps.

### Step 2:

The terminal performs local preprocessing and segmentation.

The terminal receives the raw audio sample streams and raw video frame sequences from Step 1 as inputs. The terminal applies a noise reduction algorithm (for example, spectral subtraction) using an audio processing library to the audio samples, and performs, when a microphone array is used, sound source localization and beamforming to emphasize signals from specified directions. The terminal applies lens distortion correction and basic filtering to the video frames using an image processing library. The terminal then segments the audio into fixed-length windows, executes voice activity detection on each window to classify frames as speech or non-speech, removes non-speech segments, and concatenates remaining speech segments into speech blocks. For each corresponding time window, the terminal selects video frames to form video blocks. As output, the terminal produces preprocessed speech blocks and video blocks with associated refined timestamps.

### Step 3:

The terminal compresses the audio and video and attaches metadata.

The terminal uses the preprocessed speech blocks and video blocks from Step 2 as inputs. The terminal applies an audio codec (for example, Opus or AAC) to each speech block to generate compressed audio files, and applies a video compression method (for example, H.264/AVC) or JPEG encoding to each video block to generate compressed video files. The terminal constructs metadata objects that include time information, a terminal identifier, a session identifier, and location information, and associates these metadata objects with the compressed files. As output, the terminal produces compressed audio files, compressed video files, and structured metadata records.

### Step 4:

The terminal transmits the preprocessed data to the server.

The terminal takes as input the compressed audio files, compressed video files, and metadata from Step 3. The terminal uses a communication library to establish an HTTPS connection with the server and constructs HTTP requests that embed the compressed files and metadata in a multipart or structured payload. The terminal sends the requests to an upload endpoint and waits for responses. The terminal updates an internal transmission status table based on success or failure codes, and enqueues failed transmissions for retry using a backoff strategy. As output, the terminal produces successfully transmitted session data on the server side and an updated local transmission status.

### Step 5:

The server receives and registers session data.

The server receives as inputs the HTTP requests containing compressed audio files, compressed video files, and metadata from Step 4. The server's web application parses the requests, stores the files in an object storage repository, and records file paths and metadata in relational database tables. The server creates task descriptors for audio analysis, video analysis, and emotion analysis, and enqueues these descriptors into an asynchronous job queue. As output, the server produces persistent storage entries for the files and metadata and queued analysis tasks identifiable by session IDs.

### Step 6:

The server performs speech recognition on the audio data.

The server takes as input the audio analysis task and the corresponding compressed audio file from Step 5. The server decodes the compressed audio to waveform data and computes acoustic features, such as Mel-frequency cepstral coefficients and log-Mel spectrograms, using an audio analysis library. The server passes the acoustic features to a trained ASR model implemented in a deep learning framework, and executes inference to generate text tokens and associated time alignments. The server groups tokens into utterances based on pauses and language cues, and stores for each utterance a start time, end time, and text string. As output, the server produces time-aligned utterance text data.

### Step 7:

The server performs speaker separation and utterance-type classification.

The server uses as input the time-aligned utterance text data and the underlying waveform or acoustic features from Step 6, as well as any direction information from the terminal. The server computes speaker embeddings for audio segments, clusters these embeddings to form speaker groups, and combines clustering results with direction information to assign each utterance to a speaker label, such as a subject or another participant. The server applies a text classification model or rule set to each utterance text to assign an utterance-type label, such as instruction, explanation, confirmation, or casual talk. As output, the server generates structured utterance records including text, time range, speaker label, and utterance-type label.

### Step 8:

The server performs video-based posture, behavior, and facial expression analysis.

The server receives as inputs the video analysis task and the corresponding compressed video file from Step 5. The server decodes the video into frames and applies a person detection model to each frame to detect person regions. The server extracts regions corresponding to the subject and uses a pose estimation model to compute body keypoints. The server classifies keypoint patterns into posture labels, such as sitting, standing, walking, or standing-up, and detects behavior events by analyzing sequences of posture labels. The server applies a facial expression classifier to the subject's face region to calculate expression scores for categories such as joy, anxiety, pain, confusion, and neutral. As output, the server produces a time-series of posture features, behavior labels, and facial expression scores with associated timestamps.

### Step 9:

The server constructs multimodal feature sequences for emotion estimation.

The server uses as input the structured utterance records from Step 7, the time-series posture and expression data from Step 8, and the audio waveform segments corresponding to the subject's utterances. The server extracts acoustic emotion features, such as pitch, energy, speaking rate, and prosody measures, from the subject's speech segments. The server aligns the acoustic features, posture labels, behavior labels, and facial expression scores on a common timeline using the timestamps. For each time slice, the server concatenates the aligned features into a multimodal feature vector and constructs a sequence of such vectors. As output, the server produces multimodal feature sequences representing the subject's behavior and vocal characteristics over time.

### Step 10:

The server estimates the emotional state over time.

The server takes as input the multimodal feature sequences from Step 9. The server feeds these sequences into a trained emotion estimation network, such as a bidirectional LSTM or transformer-based sequence model, and performs forward passes to compute, for each time step, probability values for emotion categories including calm, anxious, angry, confused, fatigued, and in pain. The server selects the category with the highest probability as a label and stores both labels and scores. The server aggregates scores over time windows, computes moving averages, and compares them against subject-specific baselines. As output, the server produces a time-series of emotional state labels and numeric emotion scores.

### Step 11:

The server extracts target utterances and behavior segments for prompting.

The server uses as inputs the structured utterance records from Step 7, the behavior labels from Step 8, and the emotional state time-series from Step 10. The server filters utterances to select instruction utterances and utterances describing the subject's condition, based on utterance-type labels and lexical patterns. The server scans behavior labels and emotion scores to identify time intervals related to specific actions where emotion scores exceed thresholds or change abruptly. The server assembles candidate segments consisting of utterances, behaviors, and emotional states for further summarization and evaluation. As output, the server produces sets of selected utterances and associated behavior-emotion segments.

### Step 12:

The server generates structured prompt sentences for the generative AI model.

The server receives as input the selected utterances and behavior-emotion segments from Step 11. The server uses predefined natural language templates to compose prompt sentences that include: conversation logs with speaker labels and timestamps, emotion labels and scores aligned with utterances, and behavior descriptions. The server fills placeholders in the templates with actual text snippets, time ranges, and numeric scores, and adds task instructions specifying whether the generative AI model should summarize instructions, extract health-related statements, or evaluate care quality. As output, the server produces task-specific prompt sentences ready to be sent to the generative AI model.

### Step 13:

The server calls the generative AI model and parses the response.

The server takes as input the prompt sentences from Step 12 and, when required, appended context data. The server sends the prompt sentences to an external or internal generative AI model endpoint via an API, specifying model parameters such as maximum token length and temperature. The generative AI model generates text outputs in response to each prompt. The server receives these outputs, then parses them according to expected section headings or delimiters, and maps parsed segments to structured fields: instruction summaries, lists of important health-related utterances, evaluation comments, and improvement suggestions. As output, the server generates structured summary information, important utterance information, and evaluation information.

### Step 14:

The server evaluates alert conditions and generates alert information.

The server uses as inputs the emotional state time-series from Step 10 and the evaluation information from Step 13. The server applies logical rules that compare emotional scores and their rates of change against thresholds for specific behavior types. The server evaluates whether conditions such as repeated high anxiety during a certain action or rapid increases in pain during a defined period are met. When a condition is satisfied, the server composes alert information that includes the relevant behavior type, time period, associated utterances, and a brief description of the detected pattern. As output, the server produces alert records linked to the corresponding session and subject.

### Step 15:

The server prepares presentation data for the user.

The server takes as input the summary information, important utterance information, evaluation information, and alert information from Steps 13 and 14. The server queries the database to gather historical data for context, and formats the combined information into presentation data structures, such as JSON objects for charts, tables, and textual reports. The server generates graph data for emotional trends, lists of summarised instructions, categorized important health statements, and tables of evaluations and alerts. As output, the server produces presentation data ready for delivery to user terminals.

### Step 16:

The user accesses and reviews the analysis results.

The user uses a user terminal and a web browser as inputs to the system by issuing HTTP requests to the server's web application. The server responds with web pages and associated presentation data from Step 15. The user's browser renders emotion trend graphs, summarized instructions, important health-related utterances, evaluation reports, and current alerts on the display. The user visually inspects these outputs and may select specific sessions or time ranges for detailed viewing. As output, the user gains a comprehensive and time-aligned view of multimodal interaction data and derived evaluations, which the server has computed and structured through the preceding processing steps.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

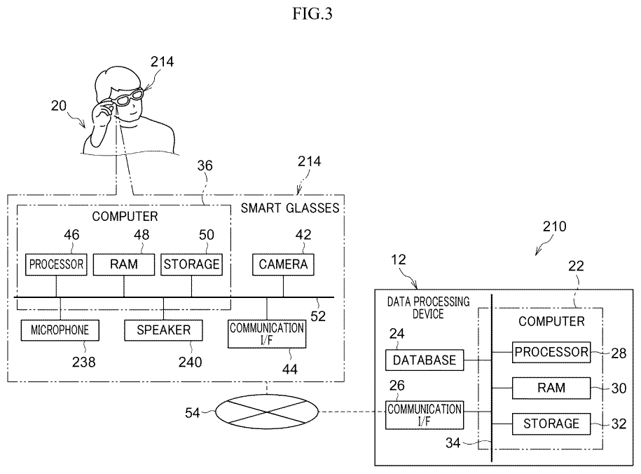

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

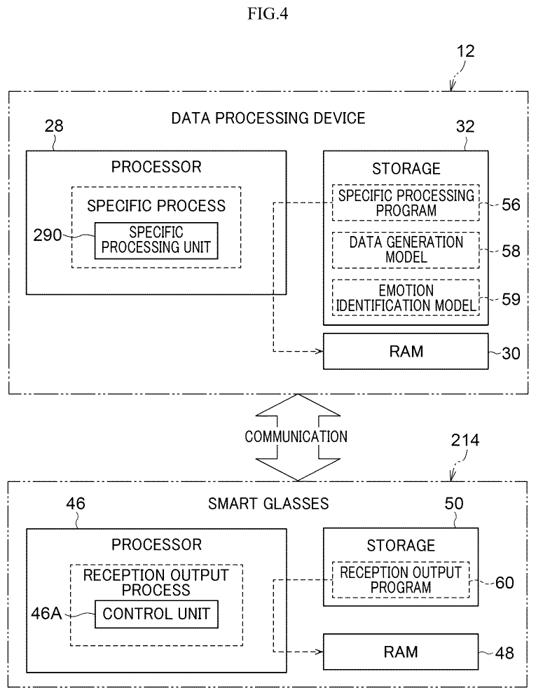

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

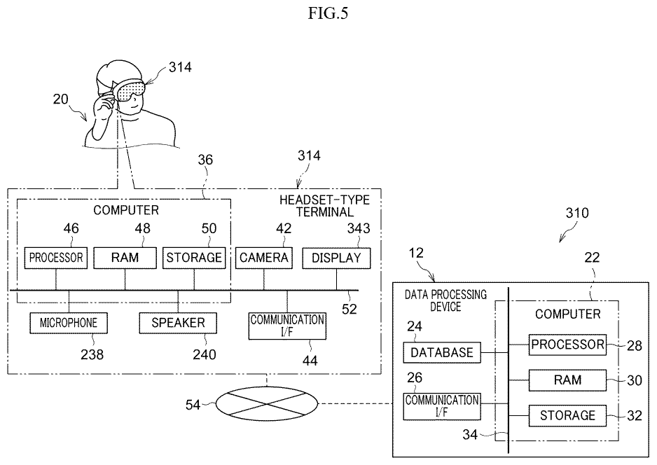

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

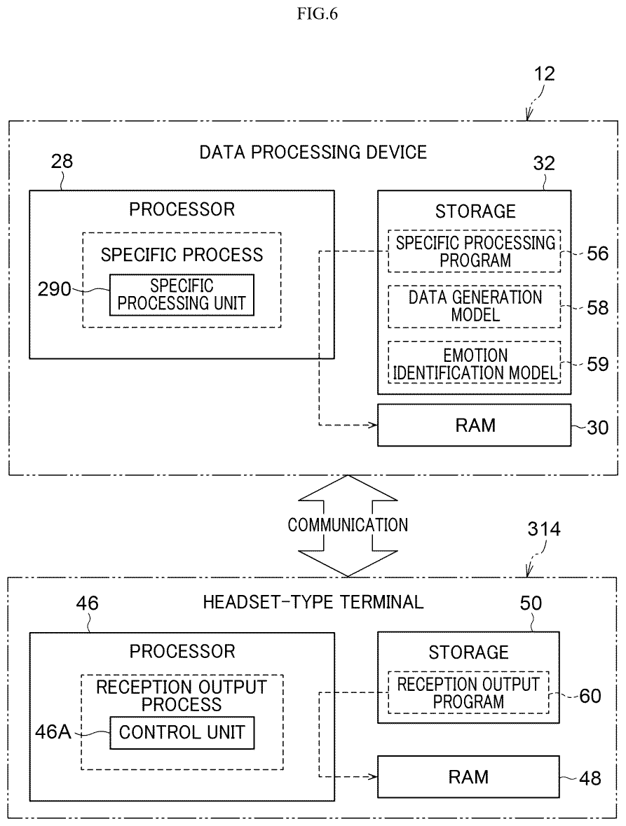

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

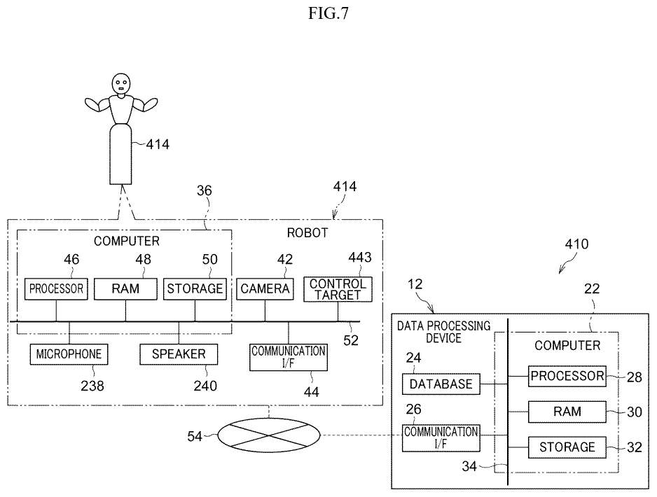

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

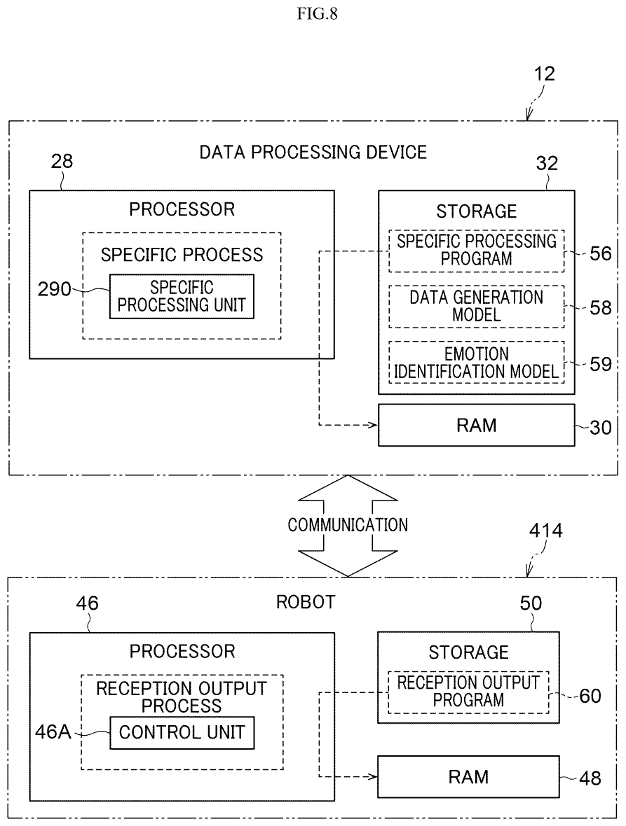

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

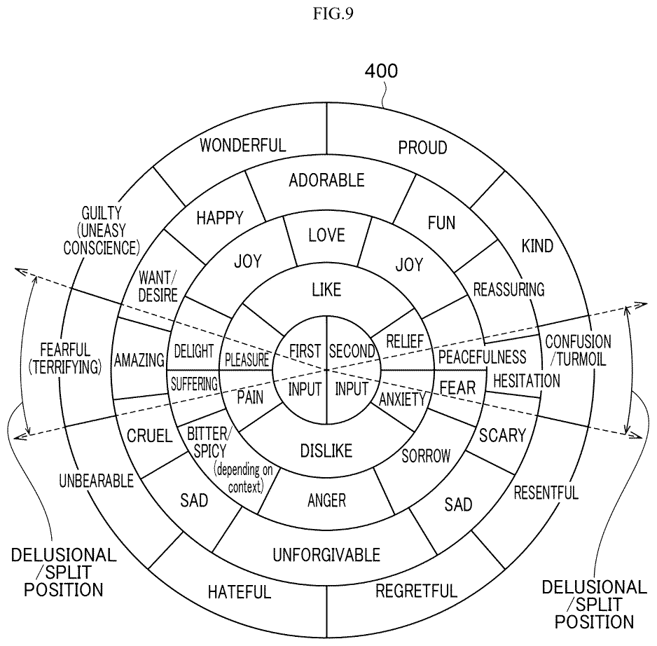

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

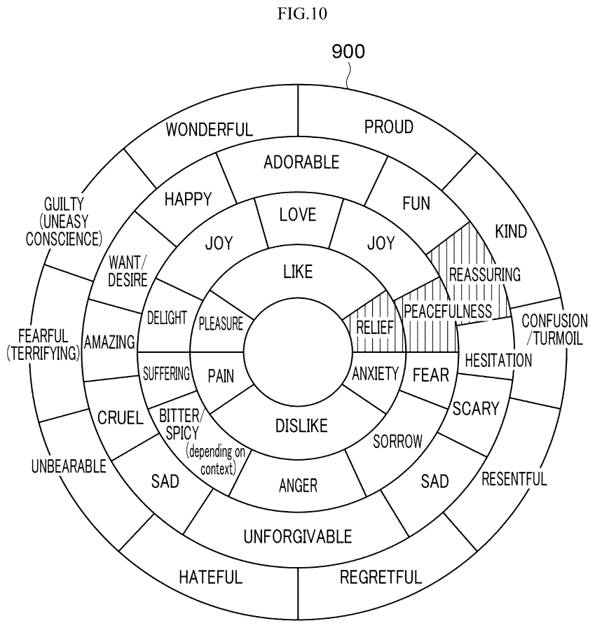

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio information in an educational space or a conference space and store the acquired audio information in association with time information in chronological order,
acquire video information in the educational space or the conference space and store the acquired video information in association with time information in chronological order,
perform compression encoding on the acquired audio information and the acquired video information, associate the encoded information with additional information including identification information and time information, and generate a data set,
transmit the data set to an information processing apparatus via a communication path, and perform retransmission control and storage control of the data set in accordance with a transmission result,
extract audio information from the data set in the information processing apparatus, execute speech recognition processing on the extracted audio information to convert the audio information into character information, and store the character information in association with the time information,
generate a prompt sentence that configures an input sentence for generating at least one of summary information, important item information, and speaker-specific information relating to a lesson or a conference, based on the character information and the time information in the information processing apparatus, and generate input data including the prompt sentence and the character information,
input the input data to a generative AI model in the information processing apparatus, acquire a generation result from the generative AI model, the generation result including at least one of key points of the lesson or the conference, important utterances, and preparation items, and store the generation result as structured information,
extract video information from the data set in the information processing apparatus, detect display content and indicating actions by executing figure information recognition processing and character recognition processing on the extracted video information, and associate the detected display content and indicating actions with the character information and the generation result based on the time information,
integrate the generation result and an analysis result obtained by the figure information recognition processing and the character recognition processing in the information processing apparatus, and generate integrated information formatted as learning material information or conference record information, and
generate notification information including the integrated information based on user identification information in the information processing apparatus and transmit the notification information to a user terminal via an electronic communication network.

### (Supplementary 2)

The system according to supplementary 1,
wherein the processor is configured to
store a plurality of types of prompt sentences that define at least one of a summary format, an output style, and a level of detail in association with at least one of a lesson type, a conference type, a target attribute, and attendance information, select at least one of the plurality of types of prompt sentences in accordance with the lesson type, the conference type, the target attribute, and the attendance information, and include the selected prompt sentence in the input data.

### (Supplementary 3)

The system according to supplementary 1,
wherein the processor is configured to
generate, based on a type of the integrated information and the user identification information, notification information including at least one of key point summary information, utterance organization information, task presentation information, and review material information, transmit the notification information via electronic mail or a communication application, and include reference information to the video information and the character information corresponding to the integrated information in the notification information.

### Application Example 1

### (Supplementary 1)

A system comprising a processor,
wherein the processor is configured to
acquire audio information from an audio recording unit that uses a high-sensitivity acoustic input device to obtain audio in a living environment in real time and to collect utterances of a plurality of speakers together with direction information and time information,
acquire video information from an image recording unit that uses an image pickup device and a wide-angle optical element to obtain video in the living environment and to record motions of a care provider and behaviors of a care recipient in association with the time information,
control a communication unit to transmit the audio information and the video information acquired by the audio recording unit and the image recording unit, together with identification information and time-series information, to an information processing apparatus,
perform, in the information processing apparatus, audio recognition processing on the audio information to generate character information, perform natural language processing on the character information to classify utterance contents according to a type of speaker and to extract important information candidates, and perform posture estimation processing and action recognition processing on the video information to extract care actions and care-recipient behaviors in association with the time information,
generate, on the basis of context information including the character information and results of the action recognition processing, a prompt sentence for a generative AI model, the prompt sentence instructing extraction of instruction contents of the care provider, extraction of utterances of the care recipient relating to a health condition, and evaluation of appropriateness of the care actions, and input the prompt sentence and the context information into the generative AI model to obtain summary information and evaluation information in a machine-readable format,
determine, on the basis of the summary information and the evaluation information, whether predetermined conditions indicating a change in the health condition, a risky behavior, or a failure to execute an emergency instruction are satisfied, generate alert information when one of the predetermined conditions is satisfied, and structure record information for each care recipient and for each care provider to generate output information, and
control the communication unit to transmit the output information and the alert information to a user terminal so that a display device of the user terminal can present time-series event information, the alert information, and the evaluation information.

### (Supplementary 2)

The system according to supplementary 1,
wherein the processor is configured to
acquire, from the user terminal, an arbitrary prompt sentence and selected recorded session information, use the arbitrary prompt sentence as an instruction for the generative AI model together with the recorded session information, and convert a response obtained from the generative AI model into a format displayable on the user terminal.

### (Supplementary 3)

The system according to supplementary 1,
wherein the processor is configured to
store, as history information, user confirmation operations or evaluation operations with respect to the summary information, the evaluation information, and the alert information,
automatically update contents of the prompt sentence or determination criteria of the predetermined conditions on the basis of the history information, and progressively improve contents of the summary information, the evaluation information, and the alert information to be generated.

### Example 2

### (Supplementary 1)

A system comprising a processor,
wherein the processor is configured to
acquire acoustic data in a classroom by controlling an acoustic acquisition unit that captures acoustic signals through one or more acoustic transducer elements,
acquire image data in the classroom by controlling an image acquisition unit that captures optical images through one or more imaging elements,
transmit the acquired acoustic data and image data from a terminal side to a server side through a communication network,
receive, at the server side, the acoustic data and the image data, and execute an acoustic recognition process on the acoustic data to generate character information representing uttered content during a lesson,
execute an image analysis process on the image data to obtain character information representing contents written on a recording surface and to obtain information relating to facial expressions and postures of persons included in the image data,
calculate, based on acoustic feature quantities derived from the acoustic data and on the facial expression information and posture information obtained from the image data, emotional indices indicating emotional states for respective time units, and generate an emotion profile representing time-series emotional states along a time axis of the lesson,
integrate the character information generated by the acoustic recognition process, the character information representing the contents written on the recording surface obtained by the image analysis process, and the emotion profile generated by the emotion profile generation process, and generate input data including the integrated information,
input the input data and a prompt sentence, which is a predetermined instruction sentence, into a generative artificial intelligence model, and cause the generative artificial intelligence model to generate summary information including main points of the lesson and
supplementary explanations based on the emotion profile, or feedback information for lesson improvement based on the emotion profile, and
distribute the generated summary information or the generated feedback information to a user terminal through the communication network.

### (Supplementary 2)

The system according to supplementary 1,
wherein the processor is configured to
execute, in the acoustic acquisition unit, a noise reduction process and a directivity control process on signals from the plurality of acoustic transducer elements by using a signal processing algorithm, thereby reducing environmental noise components and estimating a main speaker direction, and output acoustic data after the noise reduction process and the directivity control process to a transmission unit that transmits the acoustic data to the server side.

### (Supplementary 3)

The system according to supplementary 1,
wherein the processor is configured to
extract, from the emotion profile, time periods in which a confusion index exceeds a predetermined threshold, emphasize character information and recording-surface information corresponding to the extracted time periods when generating the input data, and include, in the prompt sentence, a description instructing the generative artificial intelligence model to generate detailed supplementary explanations for the time periods having the high confusion index and to describe discussion contents and atmosphere for time periods in which an interest index or an excitement index is high, thereby causing the generative artificial intelligence model to generate the summary information or the feedback information reflecting emotional states during the lesson.

### Application Example 2

### (Supplementary 1)

A system comprising a processor,
wherein the processor is configured to
acquire audio signals from an environment and record the audio signals as audio data, acquire video signals from the environment and record the video signals as video data,
associate time information and identification information with the audio data and the video data, segment the audio data and the video data into units of a predetermined time length,
perform silent-section removal on the audio data, perform compression processing on the audio data and the video data, and store the processed audio data and video data as preprocessed data,
transmit the preprocessed audio data, the preprocessed video data, and associated metadata to an information processing apparatus via a communication path, and manage a transmission state for the preprocessed audio data and the preprocessed video data,
perform acoustic analysis and language analysis on the audio data to generate text data including speaker information and time information, and perform speaker separation and utterance-type classification on the text data,
perform image processing and pattern recognition on the video data to extract feature information indicating posture information, behavior information, and facial expression information of a subject, and associate the feature information with the time information,
integrate the text data and acoustic feature information derived from the audio data with the posture information and the facial expression information derived from the video data, and estimate an emotional state of the subject and a change in the emotional state over time based on a time-series of multimodal feature information,
analyze the text data, the posture information, the behavior information, and the emotional state to extract and classify instructions directed to the subject and utterances relating to a condition of the subject, generate a prompt sentence including the extracted information and the emotional state, transmit the prompt sentence to a generative AI model, and obtain, from the generative AI model, response information including summary information, important utterance information, and evaluation information,
determine whether a condition indicating an abnormal emotional change or a problem in behavior is satisfied based on the estimated emotional state and the evaluation information, and generate alert information corresponding to the condition when the condition is satisfied, and
store the summary information, the important utterance information, the evaluation information, and the alert information, and provide presentation data based on the stored information to a user terminal.

### (Supplementary 2)

The system according to supplementary 1,
wherein the processor is configured to extract, from the text data, only instruction utterances directed to the subject, associate the instruction utterances with temporal changes in the emotional state, generate the prompt sentence including a listing of instruction contents and a description of emotional changes before and after each instruction, and cause the generative AI model to generate the summary information for the instruction contents based on the prompt sentence.

### (Supplementary 3)

The system according to supplementary 1,
wherein the processor is configured to evaluate time-series data of the emotional state, and,
when a condition is satisfied in which an index of an anxious state or a painful state repeatedly exceeds a threshold during a predetermined behavior type, or in which the emotional state exhibits a deteriorating trend over a predetermined period, generate the alert information including the behavior type, a corresponding time period, and related utterance contents.

What is claimed is:

1. A system comprising:
circuitry configured to:
acquire, via a communication interface coupled to a packet-switched network, time-synchronized audio information and video information captured from an environment;
perform compression encoding on the audio information and the video information and generate a data set associated with identification information and time information;
execute speech recognition processing on the audio information to generate character information stored in association with the time information;
generate a prompt sentence for a generative AI model on the basis of the character information, the time information, and session attribute information;
construct input data comprising the prompt sentence and the character information, input the input data to the generative AI model, and obtain a generation result including structured information comprising at least one of key point data, utterance organization data, and task data;
execute figure recognition processing and character recognition processing on the video information and associate detected display content with the character information and the generation result on the basis of the time information;
integrate the structured information and visual analysis results into integrated information; and
transmit notification information including the integrated information to a user terminal via the packet-switched network on the basis of user identification information.

2. The system according to claim 1, wherein the circuitry is further configured to perform noise cancellation processing on the audio information prior to the speech recognition processing, the noise cancellation processing comprising at least one of spectral subtraction processing, adaptive filtering processing, and beamforming processing using a plurality of acoustic transducer elements.

3. The system according to claim 2, wherein the circuitry is further configured to execute the speech recognition processing by extracting acoustic features comprising at least one of Mel-frequency cepstral coefficients and log-Mel spectrograms from the audio information, and inputting the acoustic features to a neural network model of an encoder-decoder architecture with attention mechanisms to generate the character information as a sequence of tokens with associated speaker labels and time stamps.

4. The system according to claim 3, wherein the circuitry is further configured to perform speaker separation processing on the character information by classifying each token according to a speaker identity, and to perform utterance-type classification on the character information to categorize each utterance as at least one of an instruction, a question, a response, or a discussion contribution.

5. The system according to claim 1, wherein the circuitry is further configured to store a plurality of prompt templates in association with metadata fields comprising at least one of a session type, a target attribute, and attendance information, select a prompt template from the plurality of prompt templates on the basis of the session attribute information, and fill template variables in the selected prompt template using session-specific parameters to generate the prompt sentence.

6. The system according to claim 5, wherein the circuitry is further configured to configure decoding parameters for the generative AI model on the basis of formatting rules specified in the prompt sentence, the decoding parameters comprising at least one of a beam search width, a top-k sampling parameter, a maximum output length, and a structural output constraint specifying numbered items or section headings.

7. The system according to claim 6, wherein the circuitry is further configured to parse the generation result by recognizing headings, numbering patterns, and key phrases, and to partition the generation result into a plurality of sections stored as structured information with explicit indexed fields comprising at least one of a key concept section, a discussion highlight section, and a preparation section.

8. The system according to claim 1, wherein the character recognition processing comprises executing an optical character recognition algorithm on regions of interest detected in the video information, the regions of interest comprising at least one of a recording surface region and a presentation display region, to detect equations, labels, and text as character information associated with the time information.

9. The system according to claim 8, wherein the figure recognition processing comprises applying at least one of edge detection, contour extraction, and shape classification to the video information to identify graphical elements comprising at least one of arrows, boxes, coordinate axes, and diagram layouts, and associating the identified graphical elements with the character information on the basis of spatial co-location within the regions of interest.

10. The system according to claim 9, wherein the circuitry is further configured to estimate indicating actions by analyzing motion vectors of a subject across sequential video frames, and to record a link between a detected indicating action, the detected display content, and a corresponding time range in the time information.

11. The system according to claim 1, wherein the integrating comprises composing a structured document including text sections derived from the structured information, inline references to image data extracted from the video information, and navigational links encoding the time information as parameters, such that selection of a navigational link causes retrieval of a corresponding segment of the audio information or the video information.

12. The system according to claim 1, wherein the circuitry is further configured to query a user database to determine an attendance status and a target attribute associated with the user identification information, and to select a subset of the integrated information and a presentation format on the basis of the attendance status and the target attribute.

13. The system according to claim 1, wherein the circuitry is further configured to estimate an emotion of a user by applying an emotion identification model to at least one of voice data derived from the audio information, facial expression data extracted from the video information, and text sentiment data derived from the character information, and to generate an emotion profile representing time-series emotional states along a time axis of a session.

14. The system according to claim 13, wherein the circuitry is further configured to extract time periods in which a confusion index derived from the emotion profile exceeds a predetermined threshold, and to include in the prompt sentence an instruction causing the generative AI model to generate detailed supplementary explanations for the character information corresponding to the extracted time periods.

15. The system according to claim 13, wherein the circuitry is further configured to generate feedback information for session improvement by including in the prompt sentence a description of time periods in which an interest index or an excitement index derived from the emotion profile is high, and causing the generative AI model to describe discussion contents and atmosphere for the time periods in the feedback information.

16. The system according to claim 1, wherein the circuitry is further configured to acquire an arbitrary prompt sentence from a user terminal and selected recorded session information, input the arbitrary prompt sentence together with the selected recorded session information to the generative AI model, and convert a response obtained from the generative AI model into a format displayable on the user terminal.

17. The system according to claim 1, wherein the circuitry is further configured to store, as history information, user confirmation operations or evaluation operations with respect to the structured information, and to automatically update contents of the prompt sentence or determination criteria on the basis of the history information to improve contents of the structured information to be generated in subsequent sessions.

18. A system comprising:
circuitry configured to:
acquire, via a communication interface operating over a packet-switched network supporting a transport-layer protocol with acknowledgment and retransmission control, time-synchronized audio information sampled at a predetermined sampling rate and video information captured at a predetermined frame rate from an environment, and store the audio information and the video information in a time-indexed data structure;
perform compression encoding on the audio information using a transform-based audio codec and on the video information using a motion-compensated prediction algorithm, segment compressed streams into data units of a predetermined duration, and generate a data set comprising a header region storing identification information and time range and a payload region storing the compressed streams;
execute speech recognition processing on the audio information by extracting acoustic features comprising Mel-frequency cepstral coefficients and log-Mel spectrograms from overlapping windows of audio samples, and inputting the acoustic features to a neural network model of an encoder-decoder architecture with attention mechanisms trained using a cross-entropy loss function to generate character information as a sequence of tokens each associated with a speaker label, a start time, and an end time;
select a prompt template from a plurality of stored prompt templates on the basis of session attribute information comprising at least one of a session type, a target attribute, and attendance information, fill template variables in the selected prompt template, and construct input data comprising the prompt sentence and the character information;
input the input data to a generative AI model implemented as a transformer-based sequence-to-sequence model comprising a multi-layer self-attention mechanism, feedforward layers, and layer normalization, execute inference using a decoding strategy comprising at least one of beam search and top-k sampling, and obtain a generation result parsed into structured information comprising at least one of key point data, utterance organization data, and task data;
execute optical character recognition on regions of interest in the video information to detect equations, labels, and text, and execute figure recognition processing comprising at least one of edge detection, contour extraction, and shape classification to identify graphical elements, and associate the detected display content with the character information and the generation result on the basis of the time information;
integrate the structured information and visual analysis results into integrated information formatted as a structured document comprising text sections, inline image references, and navigational links encoding the time information; and
generate notification information including the integrated information on the basis of user identification information and an attendance status, and transmit the notification information to a user terminal via the packet-switched network.

19. The system according to claim 18, wherein the circuitry is further configured to estimate an emotion of a user by applying an emotion identification model to at least one of acoustic feature data derived from the audio information and facial expression data extracted from the video information, calculate emotional indices comprising at least one of a confusion index, an interest index, and an excitement index for respective time units, and adjust a detail level or a priority of content included in the structured information on the basis of the emotional indices.

20. A method performed by circuitry of a system, the method comprising:
acquiring, via a communication interface coupled to a packet-switched network, time-synchronized audio information and video information captured from an environment;
performing compression encoding on the audio information and the video information and generating a data set associated with identification information and time information;
executing speech recognition processing on the audio information to generate character information stored in association with the time information;
generating a prompt sentence for a generative AI model on the basis of the character information, the time information, and session attribute information;
constructing input data comprising the prompt sentence and the character information, inputting the input data to the generative AI model, and obtaining a generation result including structured information comprising at least one of key point data, utterance organization data, and task data;
executing figure recognition processing and character recognition processing on the video information and associating detected display content with the character information and the generation result on the basis of the time information;
integrating the structured information and visual analysis results into integrated information; and
transmitting notification information including the integrated information to a user terminal via the packet-switched network on the basis of user identification information.
